(19) United States
(12) Patent Application Publication
(10) Pub. No.: US 2021/0365170 A1
(43) Pub. Date: Nov. 25, 2021

(54) LOW POWER TOUCH REMOTE

(71) Applicant: Current Products Corp., Pensacola, FL (US)

(72) Inventors: Willis J. Mullet, Gulf Breeze, FL (US); Scott Hand, Pace, FL (US); Sean Scalf, Pensacola, FL (US); Curtis Scott, Milton, FL (US); Phillip Dugger, Pensacola, FL (US)

(21) Appl. No.: 17/321,756

(22) Filed: May 17, 2021

Related U.S. Application Data
(60) Provisional application No. 63/026,944, filed on May 19, 2020.

(51) Int. Cl. G06F 3/041; G08C 17/02

(52) U.S. Cl. CPC G06F 3/04166; G08C 17/02; E06B 9/368; G08C 2201/30; G08C 2201/12

(57) ABSTRACT

In one or more arrangements, a power efficient remote control system is presented. The remote control system has a touch based interface having a plurality of touch sensitive sensors. The remote control system is configured to operate in an active mode in response to user input and operate in a background mode in response to inactivity. In the active mode, a control circuit of the remote control system is configured to monitor touch activity by sampling signals from outputs from a plurality of touch sensitive sensors individually. In the background mode, power is saved by electrically connecting outputs of the plurality of touch sensitive sensors together and monitoring touch activity by sampling a signal from the connected outputs of the plurality of touch sensitive sensors together.

### CROSS REFERENCE TO RELATED APPLICATIONS

This application claims priority to U.S. Provisional Application No. 63/026,944 filed May 19, 2020 and titled LOW POWER TOUCH REMOTE, which is hereby fully incorporated by reference herein in its entirety.

### FIELD OF THE DISCLOSURE

This disclosure relates to control technology, such as remote controls. More specifically, and without limitation, this disclosure relates to touch-based remote control systems.

### Overview:

Conventional remote controls are widely utilized to remotely control various electronic devices such as garage doors, television sets and door locks on vehicles, to name a few. While the capability, range, durability and functionality of remote controls have improved over time, substantial deficiencies still exist in the art. One deficiency with current remote technologies is limited timespan that remotes remain operable on a single power supply. This deficiency is exasperated by the desire for more power hungry features that enhance usability from a user perspective. Such features may include, for example, lighted controls and displays, fast responsiveness, touch interfaces, long range control communications, etc.

Window coverings, such as curtains, shades, draperies and the like are frequently used to provide privacy and to limit the amount of light that is permitted to pass through a window and into a room or building. There are countless types, forms and designs of window coverings known in the art. The term window covering is used to describe any and all of these types, forms and designs including blinds, shades, draperies, and the like.

One form of a window covering, of particular interest in this application, is a roll shade (hereinafter “roll shade”). Common components of roll shades include a roll tube rotatably connected to brackets on opposing ends. The roll shade is positioned above or adjacent to a window or door. In one arrangement of a roll shade, shade material is wrapped around the roll tube and connected to a bottom bar, as the roll tube rotates the shade material is wrapped or unwrapped around the roll tube thereby opening and closing the roll shade.

Another form of window covering, of particular interest in this application, is a honeycomb shade and Venetian shade (hereinafter “honeycomb shade” and “venetian shade”). Common components of honeycomb shades and Venetian shades include a header and a bottom bar with shade material extending there between. In the case of a honeycomb shade a single panel of material extends between the header and the bottom bar, whereas, in the case of a Venetian shade, a plurality of slats are held within ladders that extend between the header and the bottom bar. Both honeycomb shades and Venetian shades have suspension cords that extend from the header to the bottom bar. These suspension cords are connected to a drive mechanism, which when actuated raise and lower the bottom bar by winding or unwinding the suspension cords.

Yet another form of a window covering, of particular interest in this application, is a drapery shade (hereinafter “drapery”). Common components of draperies include a support rod connected at its ends to brackets and shade material connected to and hanging down from the support rod. Drapery shades can include blackout shades and sheer shades which can be independently opened and controlled by laterally sliding or moving them along the support rod.

Recent improvements in motorization and motor control technologies have allowed manufacturers to motorize these various window coverings in new ways. While the motorization of window coverings has provided certain advantages, one deficiency is that conventional remote control technology does not provide the ability to sufficiently manipulate and control these improved motorized window coverings.

Furthermore, recent improvements in motorization and motor control technologies have failed to come up with improved technologies for ease of installation and use of remote controls in controlling window coverings and the like. There is a need in the art for convenient remote control installation packages, techniques, and the like. The need for simplified, even foolproof, installation has become ever more important with new generations of users who may lack the tools and/or capabilities to install complex window covering assemblies and remote controls, or simply newer generations of users which expect more ease and access of controls.

Thus, it is an object of the disclosure to provide a remote control system having touch control interface that improves upon the state of the art.

Yet another object of the disclosure is to provide a remote control system that is power efficient.

Another object of the disclosure is to provide a remote control system having touch control interface capable of independently controlling different sets of devices.

Yet another object of the disclosure is to provide a remote control system that is user friendly to use.

Another object of the disclosure is to provide a remote control system that can be conveniently located.

Yet another object of the disclosure is to provide a remote control system that provides improved functionality.

Another object of the disclosure is to provide a remote control system that is aesthetically pleasing.

Yet another object of the disclosure is to provide a remote control system that can be easily removed from a surface for use.

Another object of the disclosure is to provide a remote control system that can be easily returned to a surface after use.

Yet another object of the disclosure is to provide a remote control system that can conceal its attachment means.

Another object of the disclosure is to provide a remote control system that is self-centering.

Yet another object of the disclosure is to provide a remote control system that is easy to install.

Yet another object of the disclosure is to provide a remote control system that is relatively inexpensive.

Another object of the disclosure is to provide a remote control system that has a minimum number of parts.

Yet another object of the disclosure is to provide a remote control system that has an intuitive design.

Another object of the disclosure is to provide a remote control system that is intuitive to install.

Yet another object of the disclosure is to provide a remote control system that has an installation that is quick.

Another object of the disclosure is to provide a remote control system that improves the accuracy of control.

Yet another object of the disclosure is to provide a remote control system that has a minimum number of buttons.

Another object of the disclosure is to provide a remote control system that provides a convenient and secure place to hold the remote.

Yet another object of the disclosure is to provide a remote control system that utilizes standard parts and components, where possible.

These and other objects, features, or advantages of the present disclosure will become apparent from the specification and claims.

### SUMMARY OF THE DISCLOSURE

In one or more arrangements, a power efficient remote control system is presented. The remote control system has a touch based interface having a plurality of touch sensitive sensors. The remote control system is configured to operate in an active mode in response to user input and operate in a background mode in response to inactivity. In the active mode, a control circuit of the remote control system is configured to monitor touch activity by sampling signals from outputs from a plurality of touch sensitive sensors individually. In the background mode, power is saved by electrically connecting outputs of the plurality of touch sensitive sensors together and monitoring touch activity by sampling a signal from the connected outputs of the plurality of touch sensitive sensors together.

### BRIEF DESCRIPTION OF THE DRAWINGS

FIG. 1 is an elevation view of a remote control system having a touch control interface, a plurality of indicator lights, and a pull tab; the view showing a perspective view of a drapery with opposing brackets placed on each end of a support bar, the drapery having a blackout curtain and a sheer curtain, in accordance with one of more embodiments.

FIG. 2 is a front elevation view of a remote control system having a touch control interface, a plurality of indicator lights, and a pull tab; the view showing a honeycomb shade with a header, a bottom bar, and shade material, in accordance with one of more embodiments.

FIG. 3 shows an upper front right perspective view of a remote control system, in accordance with one of more embodiments; the view showing the system having an upper touch control slider positioned on a front of the system and a lower touch control slider positioned behind a sequence of markings on the front of the system.

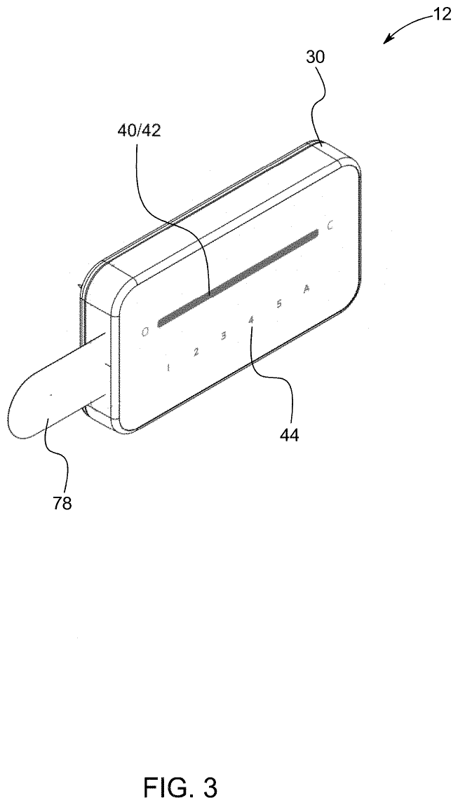

FIG. 4 shows a top view of a remote control system, in accordance with one of more embodiments; the view showing the system having an upper touch control slider positioned on a front of the system and a lower touch control slider positioned behind a sequence of markings on the front of the system.

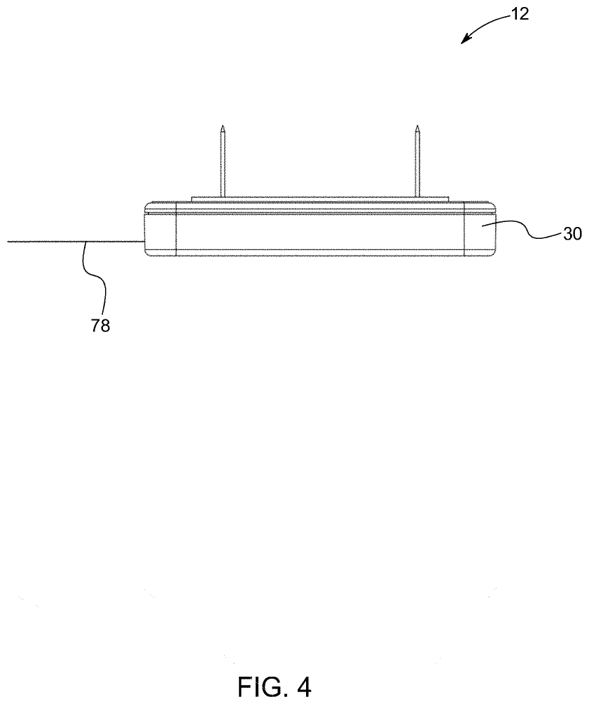

FIG. 5 shows an upper front left perspective view of a remote control system, in accordance with one of more embodiments; the view showing the system having an upper touch control slider positioned on a front of the system and a lower touch control slider positioned behind a sequence of markings on the front of the system.

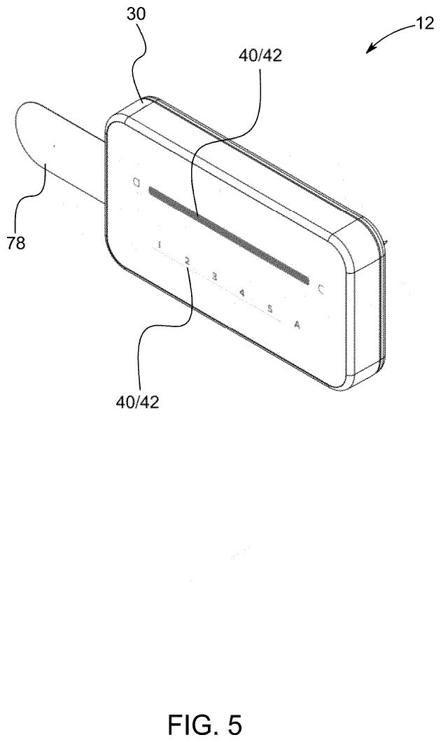

FIG. 6 shows a right side view of a remote control system, in accordance with one of more embodiments; the view showing the system having an upper touch control slider positioned on a front of the system and a lower touch control slider positioned behind a sequence of markings on the front of the system.

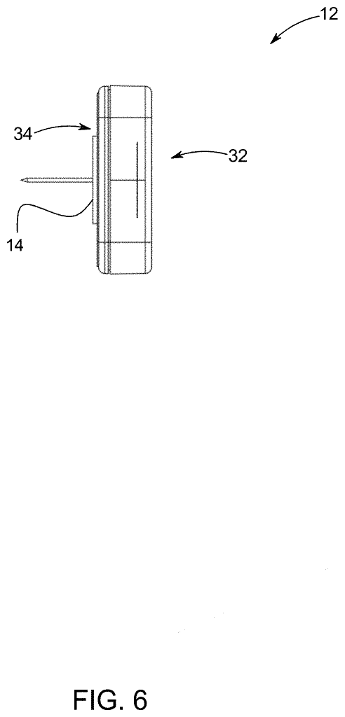

FIG. 7 shows a front view of a remote control system, in accordance with one of more embodiments; the view showing the system having an upper touch control slider positioned on a front of the system and a lower touch control slider positioned behind a sequence of markings on the front of the system.

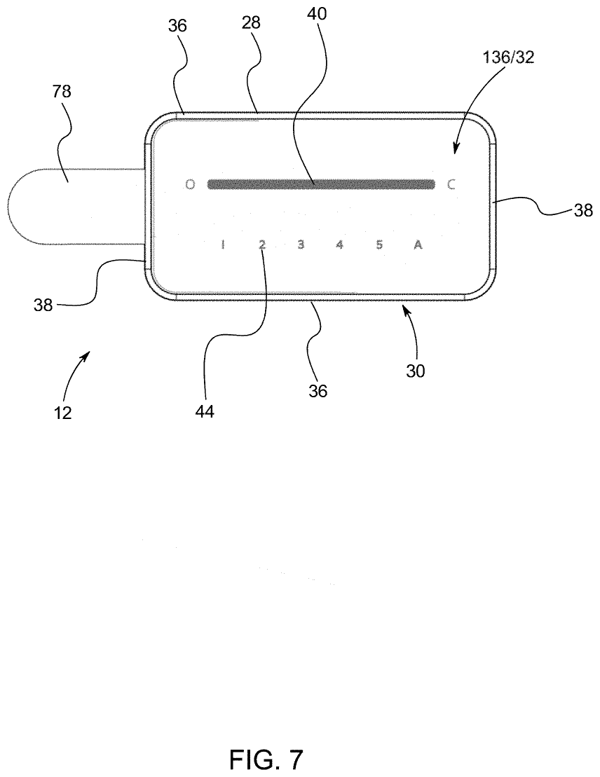

FIG. 8 shows a left side view of a remote control system, in accordance with one of more embodiments; the view showing the system having an upper touch control slider positioned on a front of the system and a lower touch control slider positioned behind a sequence of markings on the front of the system.

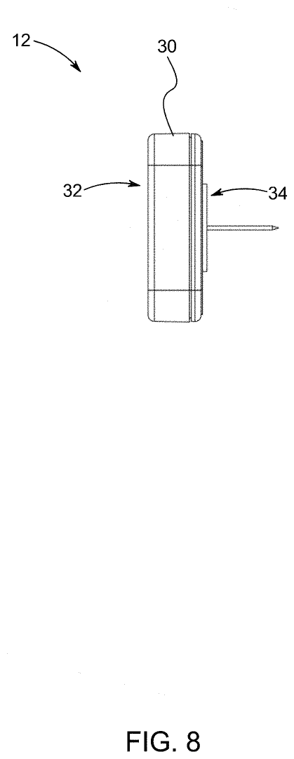

FIG. 9 shows a lower front right perspective view of a remote control system, in accordance with one of more embodiments; the view showing the system having an upper touch control slider positioned on a front of the system and a lower touch control slider positioned behind a sequence of markings on the front of the system.

FIG. 10 shows a bottom view of a remote control system, in accordance with one of more embodiments; the view showing the system having an upper touch control slider positioned on a front of the system and a lower touch control slider positioned behind a sequence of markings on the front of the system.

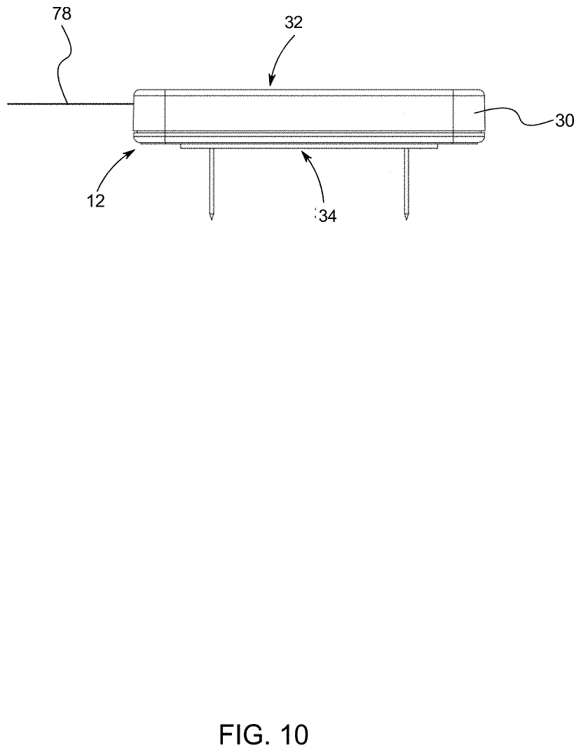

FIG. 11 shows a lower front left perspective view of a remote control system, in accordance with one of more embodiments; the view showing the system having a lower touch control slider positioned behind a sequence of markings “1 2 3 4 5 A” and an upper touch control slider positioned above the lower touch control slider.

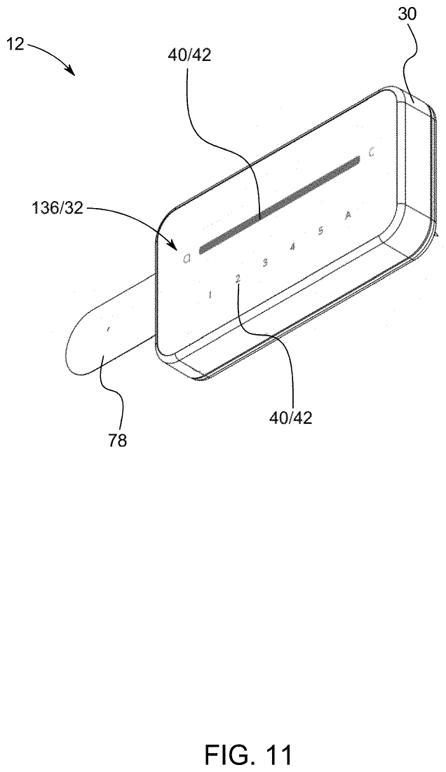

FIG. 12 shows an exploded upper front left perspective view of a remote control system, in accordance with one of more embodiments; the view showing the system having an upper touch control slider positioned on a front of the system and a lower touch control slider positioned behind a sequence of markings on the front of the system.

FIG. 13 shows an upper front right perspective view of a remote control system, in accordance with one of more embodiments; the view showing the system having upper and lower touch control slider positioned on the front of the system.

FIG. 14 shows a top view of a remote control system, in accordance with one of more embodiments; the view showing the system having upper and lower touch control slider positioned on the front of the system.

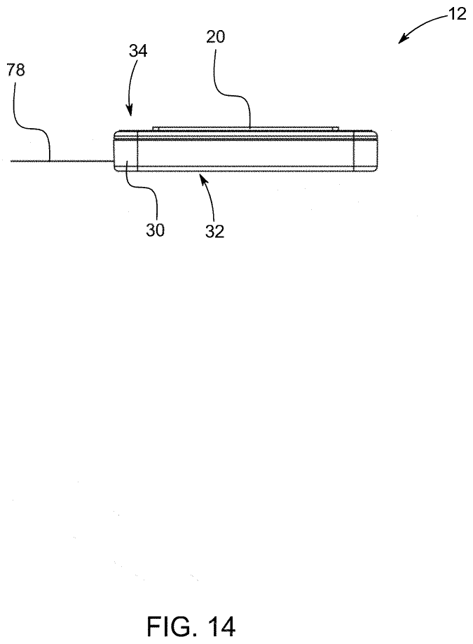

FIG. 15 shows an upper front left perspective view of a remote control system, in accordance with one of more embodiments; the view showing the system having upper and lower touch control slider positioned on the front of the system.

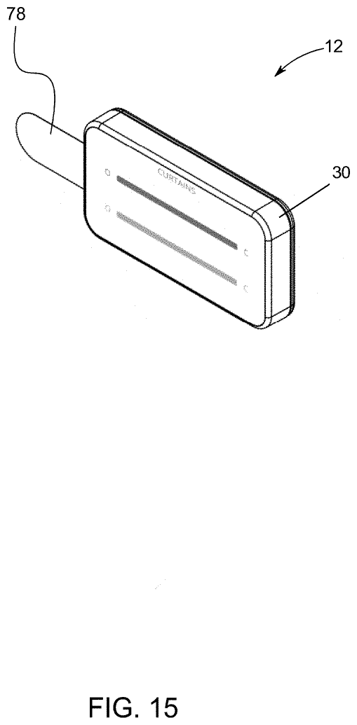

FIG. 16 shows a right side view of a remote control system, in accordance with one of more embodiments; the view showing the system having upper and lower touch control slider positioned on the front of the system.

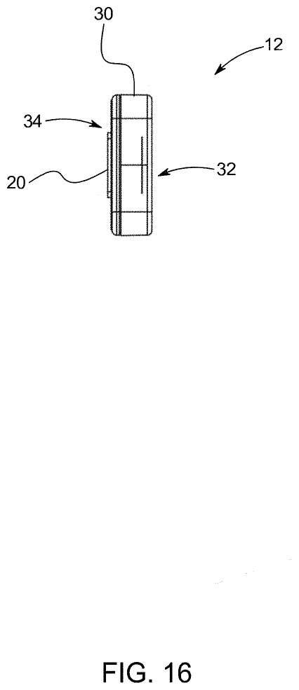

FIG. 17 shows a front view of a remote control system, in accordance with one of more embodiments; the view showing the system having upper and lower touch control slider positioned on the front of the system.

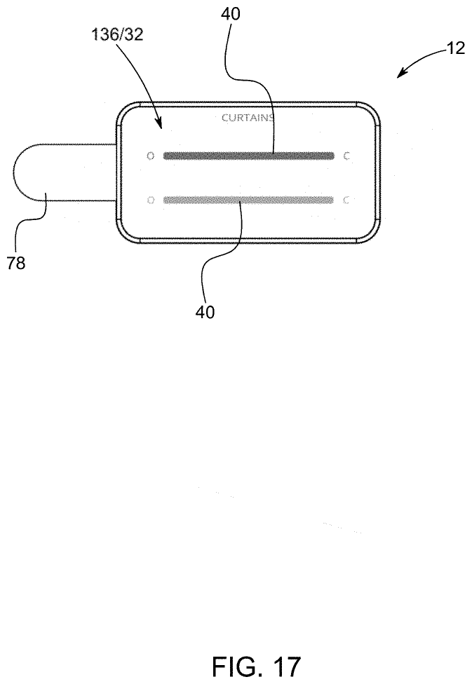

FIG. 18 shows a left side view of a remote control system, in accordance with one of more embodiments; the view showing the system having upper and lower touch control slider positioned on the front of the system.

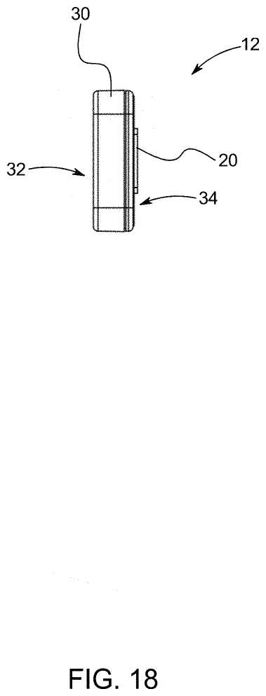

FIG. 19 shows a lower front right perspective view of a remote control system, in accordance with one of more embodiments; the view showing the system having upper and lower touch control slider positioned on the front of the system.

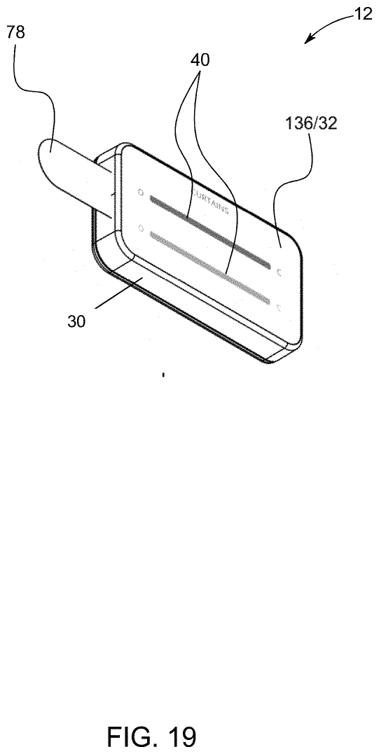

FIG. 20 shows a bottom view of a remote control system, in accordance with one of more embodiments; the view showing the system having upper and lower touch control slider positioned on the front of the system.

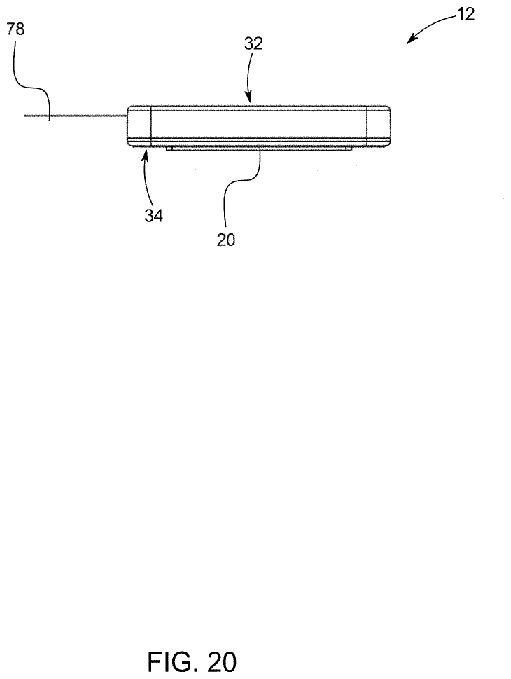

FIG. 21 shows a lower front left perspective view of a remote control system, in accordance with one of more embodiments; the view showing the system having upper and lower touch control slider positioned on the front of the system.

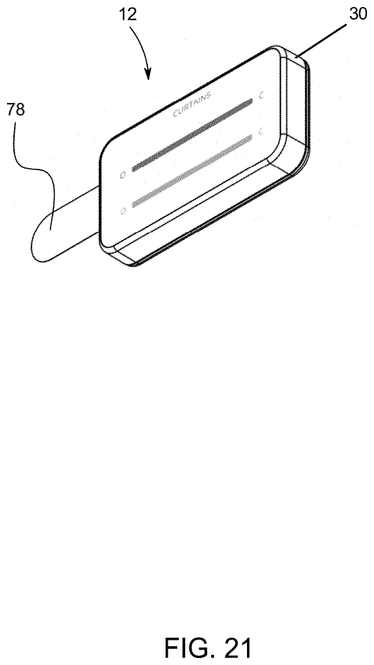

FIG. 22 shows an exploded upper front left perspective view of a remote control system, in accordance with one of more embodiments; the view showing the system having upper and lower touch control slider positioned on the front of the system.

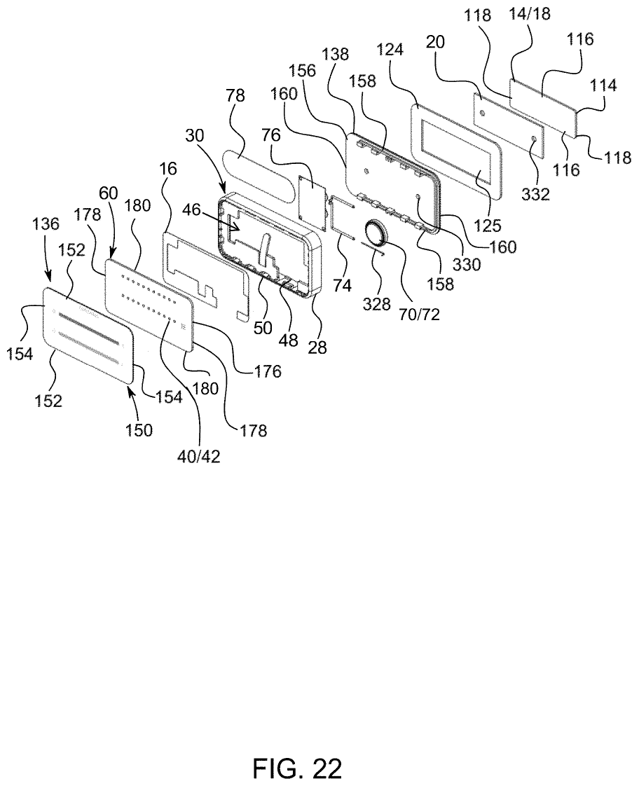

FIG. 23 shows an upper front right perspective view of a remote control system, in accordance with one of more embodiments; the view showing the system having upper and lower touch control slider positioned on the front of the system; the view showing the system having a base configured to facilitate use as a table top remote control.

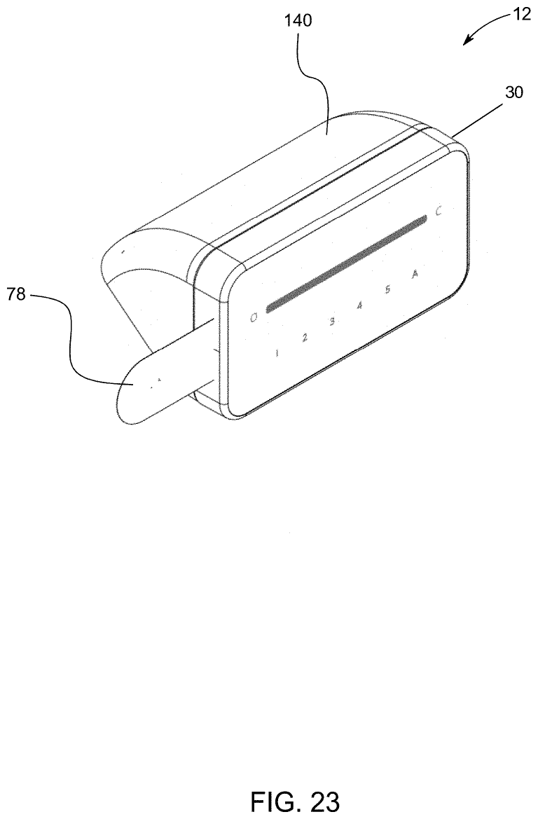

FIG. 24 shows a top view of a remote control system, in accordance with one of more embodiments; the view showing the system having upper and lower touch control slider positioned on the front of the system; the view showing the system having a base configured to facilitate use as a table top remote control.

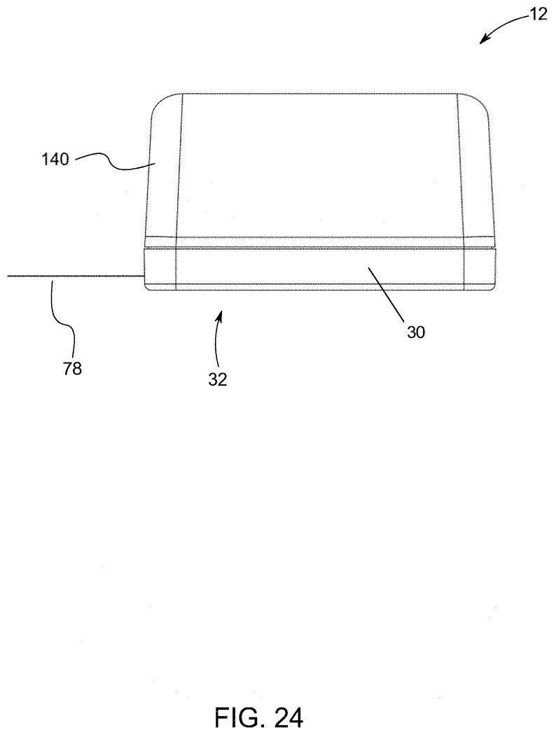

FIG. 25 shows an upper front left perspective view of a remote control system, in accordance with one of more embodiments; the view showing the system having upper and lower touch control slider positioned on the front of the system; the view showing the system having a base configured to facilitate use as a table top remote control.

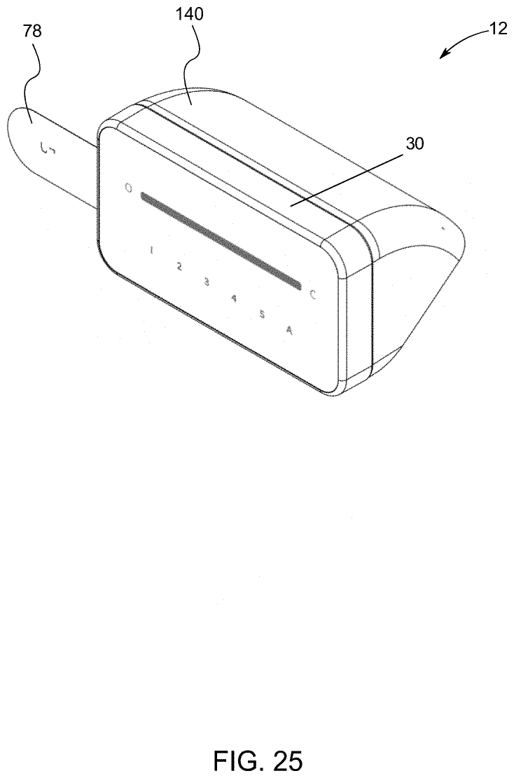

FIG. 26 shows a right side view of a remote control system, in accordance with one of more embodiments; the view showing the system having upper and lower touch control slider positioned on the front of the system; the view showing the system having a base configured to facilitate use as a table top remote control.

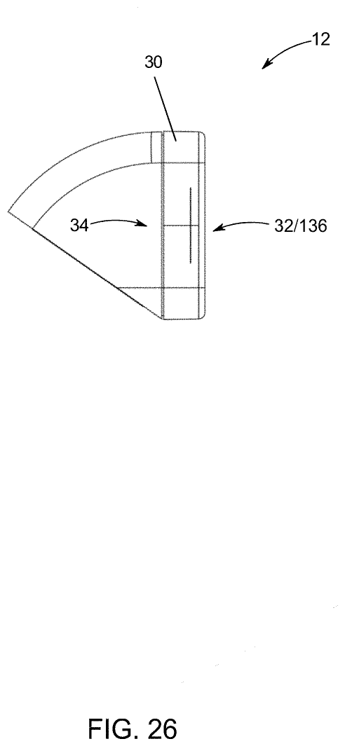

FIG. 27 shows a front view of a remote control system, in accordance with one of more embodiments; the view showing the system having upper and lower touch control slider positioned on the front of the system; the view showing the system having a base configured to facilitate use as a table top remote control.

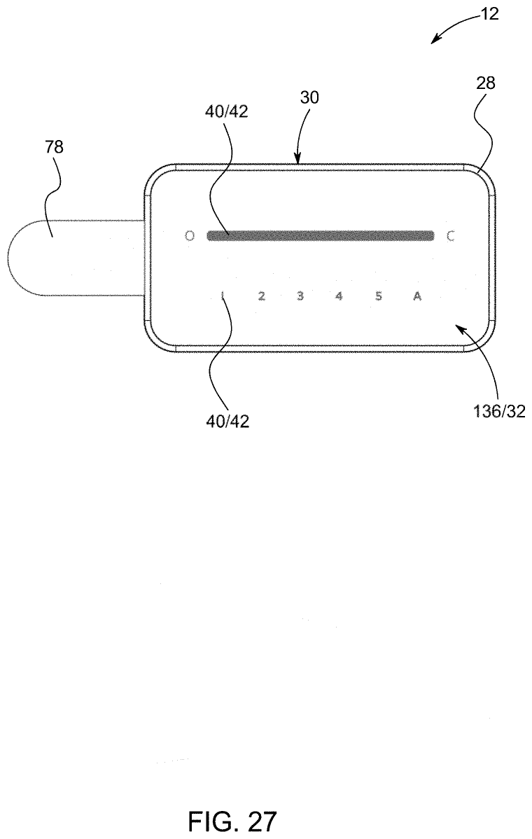

FIG. 28 shows a left side view of a remote control system, in accordance with one of more embodiments; the view showing the system having upper and lower touch control slider positioned on the front of the system; the view showing the system having a base configured to facilitate use as a table top remote control.

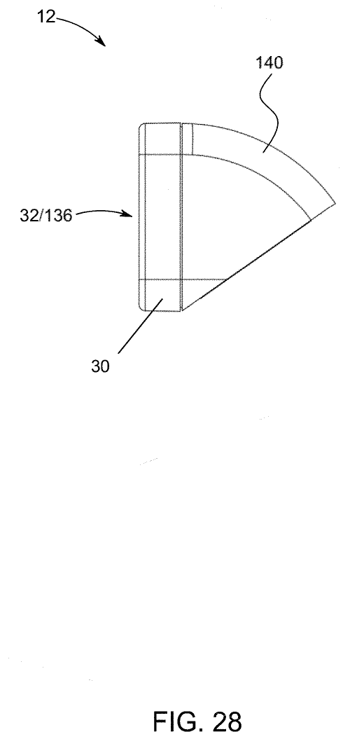

FIG. 29 shows a lower front right perspective view of a remote control system, in accordance with one of more embodiments; the view showing the system having upper and lower touch control slider positioned on the front of the system; the view showing the system having a base configured to facilitate use as a table top remote control.

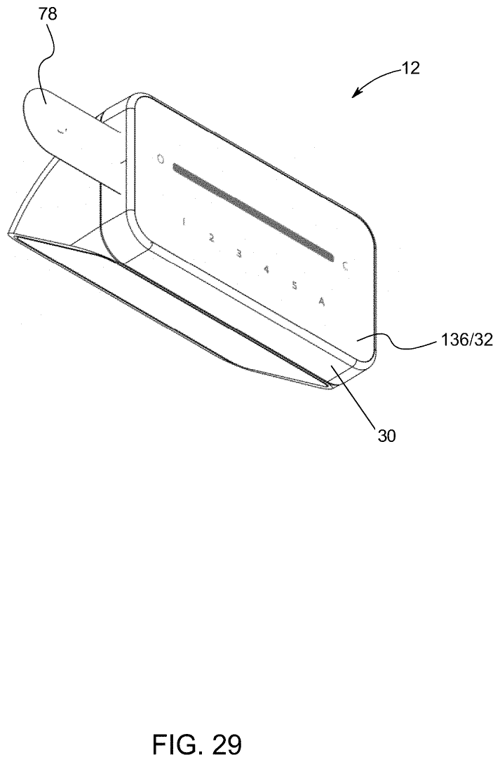

FIG. 30 shows a bottom view of a remote control system, in accordance with one of more embodiments; the view showing the system having upper and lower touch control slider positioned on the front of the system; the view showing the system having a base configured to facilitate use as a table top remote control.

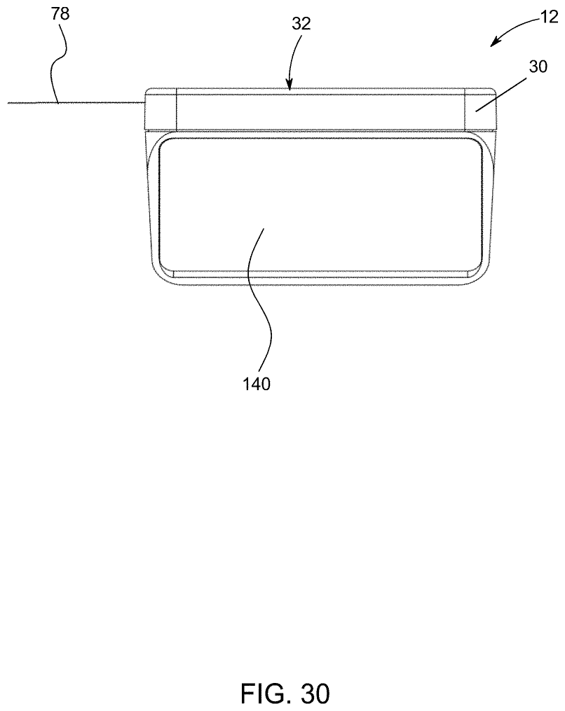

FIG. 31 shows a lower front left perspective view of a remote control system, in accordance with one of more embodiments; the view showing the system having upper and lower touch control slider positioned on the front of the system; the view showing the system having a base configured to facilitate use as a table top remote control.

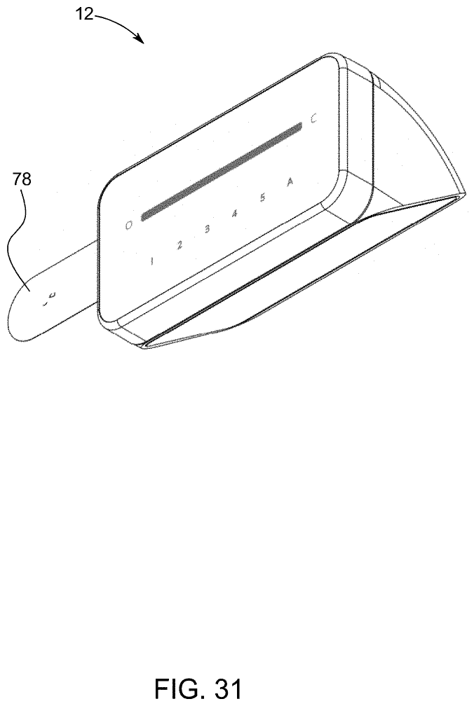

FIG. 32 shows an exploded upper front left perspective view of a remote control system, in accordance with one of more embodiments; the view showing the system having upper and lower touch control slider positioned on the front of the system; the view showing the system having a base configured to facilitate use as a table top remote control.

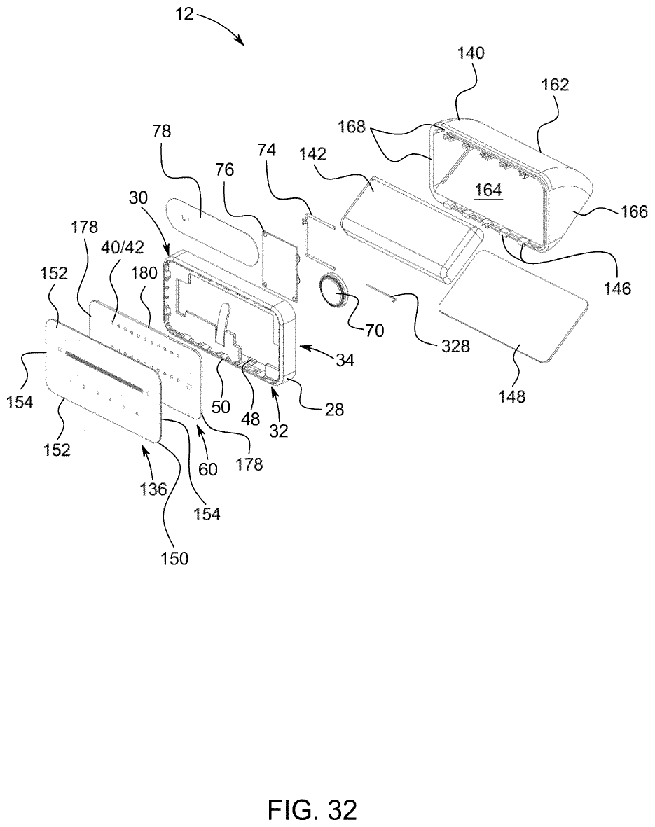

FIG. 33 shows a front view of a first example circuit board for a remote control system, in accordance with one of more embodiments.

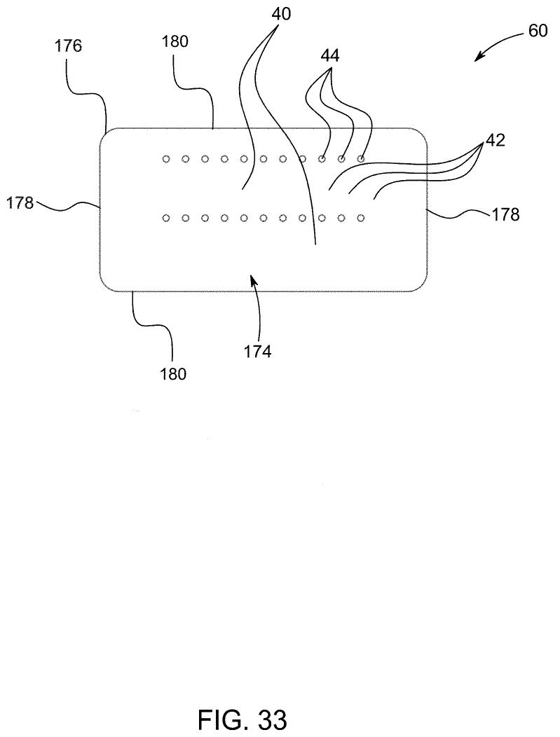

FIG. 34 shows an upper front left perspective view of the circuit board shown in FIG. 33, in accordance with one of more embodiments.

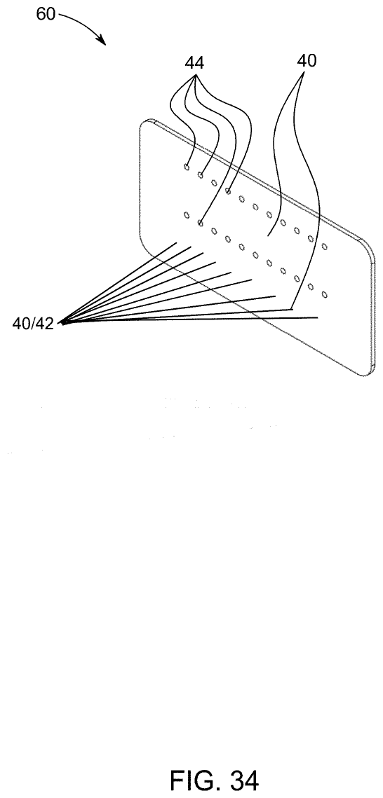

FIG. 35 shows a back view of a circuit board shown in FIG. 33, in accordance with one of more embodiments.

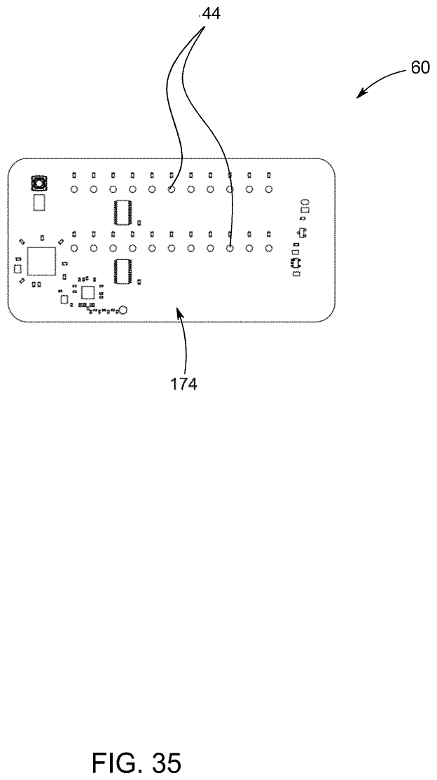

FIG. 36 shows an upper back right perspective view of a circuit board shown in FIG. 33 in accordance with one of more embodiments.

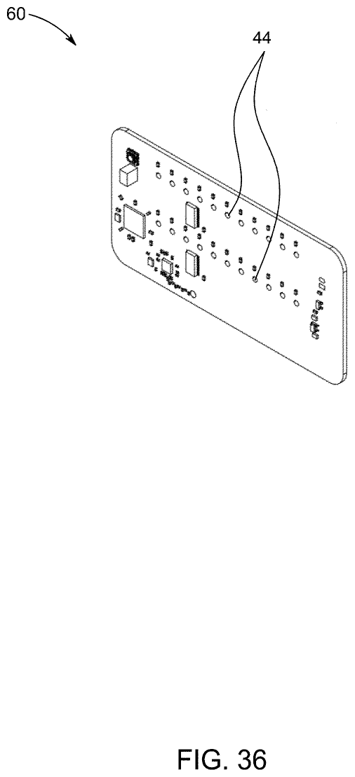

FIG. 37 shows a front view of a second example circuit board for a remote control system, in accordance with one of more embodiments.

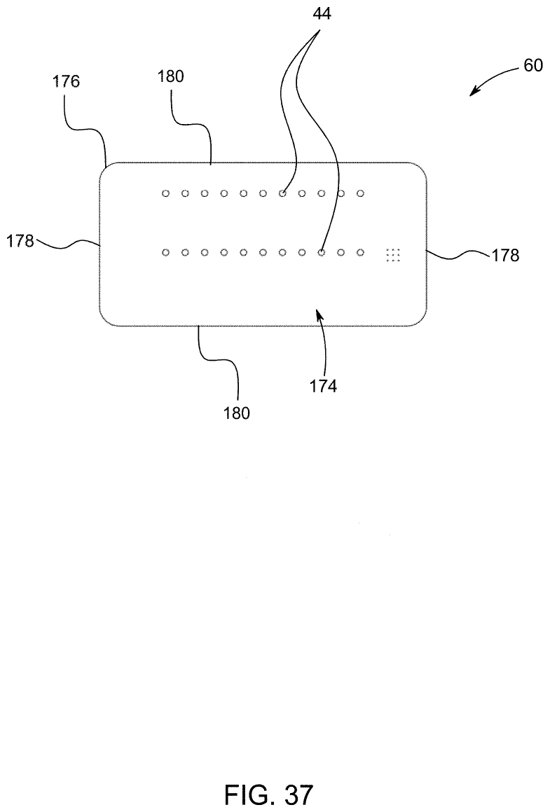

FIG. 38 shows an upper front left perspective view of the circuit board shown in FIG. 37, in accordance with one of more embodiments.

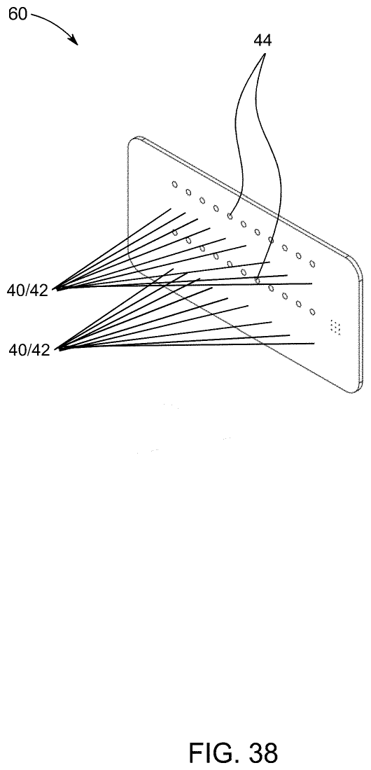

FIG. 39 shows a back view of a circuit board shown in FIG. 37, in accordance with one of more embodiments.

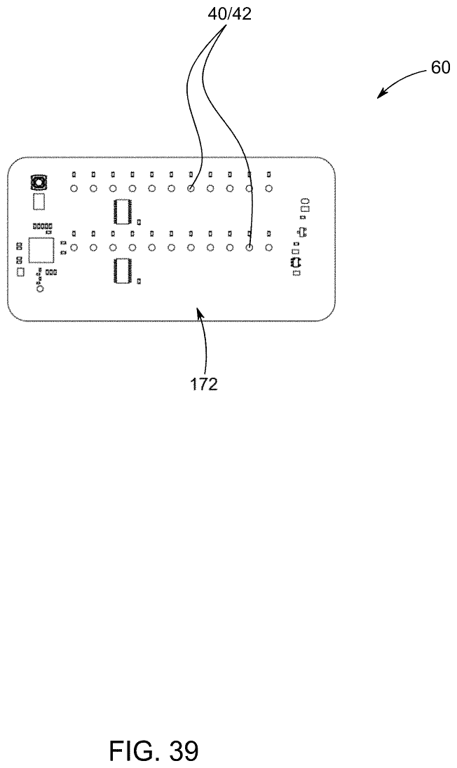

FIG. 40 shows an upper back right perspective view of a circuit board shown in FIG. 37 in accordance with one of more embodiments.

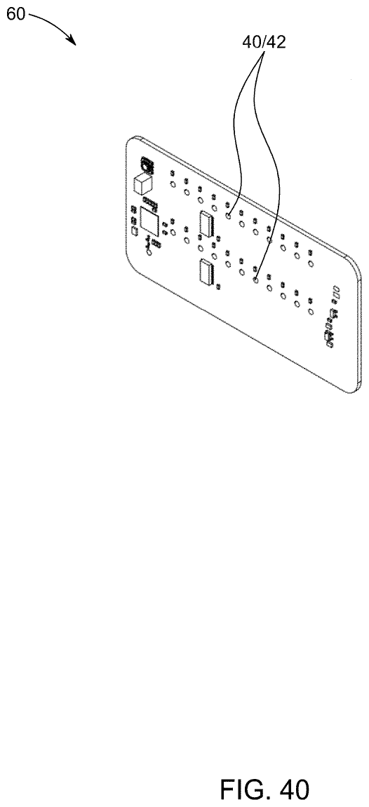

FIG. 41 shows a front view of a remote control system, in accordance with one of more embodiments; the view showing the system having an upper touch control slider positioned on a front of the system and a lower touch control slider positioned behind a sequence of markings on the front of the system.

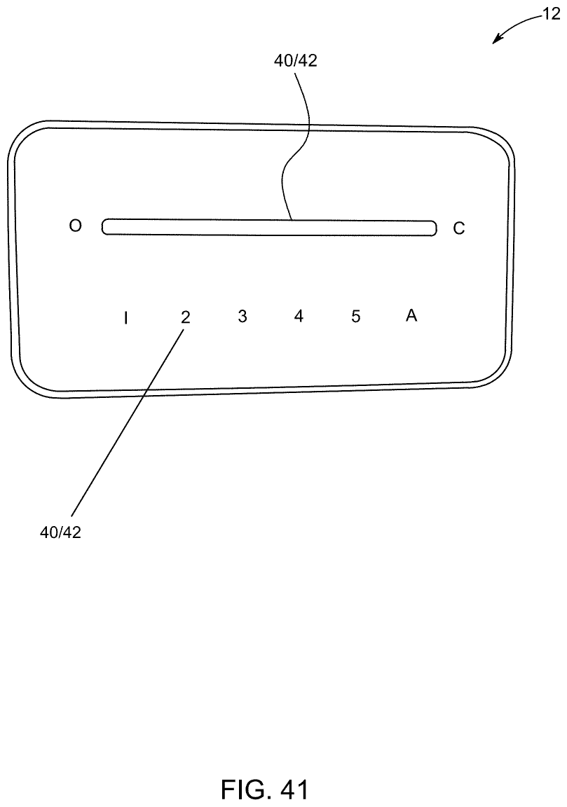

FIG. 42 shows a front view of a remote control system, in accordance with one of more embodiments; the view showing the system having an upper touch control slider positioned on a front of the system and a lower touch control slider positioned behind a sequence of markings on the front of the system; the view showing the system having indictors positioned above the upper and lower touch control sliders.

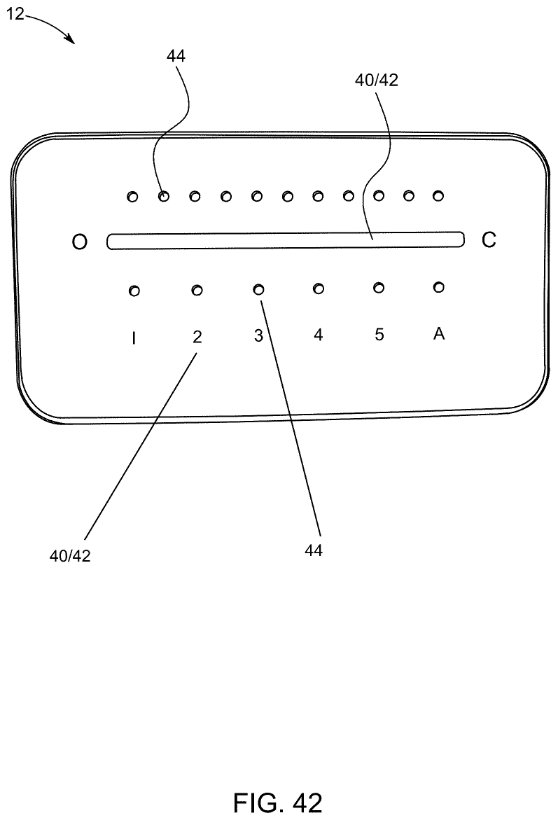

FIG. 43 shows a front view of a remote control system, in accordance with one of more embodiments; the view showing the system having a base configured to facilitate use as a table top remote control; the view showing the system having an upper touch control slider positioned on a front of the system and a lower touch control slider positioned behind a sequence of markings on the front of the system; the view showing the system having indictors positioned above the upper and lower touch control sliders.

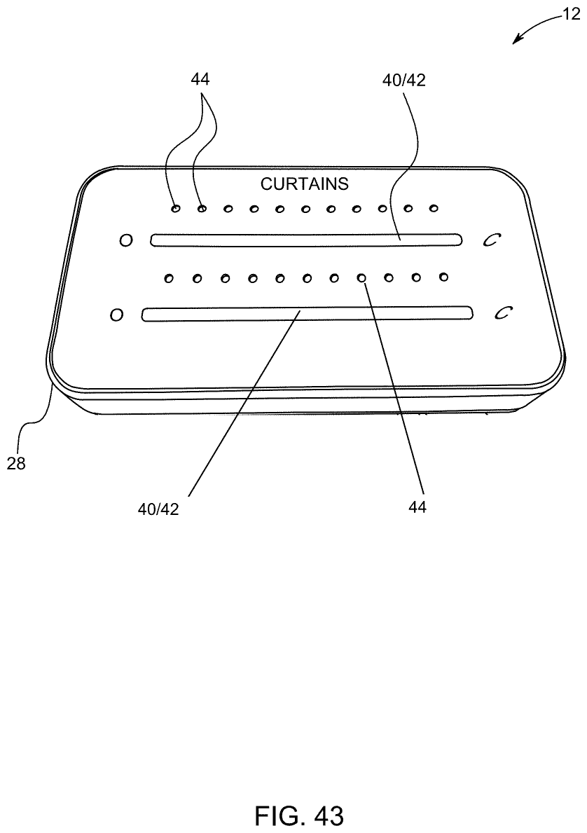

FIG. 44 shows a front left perspective view of a remote control system shown in FIG. 43, in accordance with one of more embodiments.

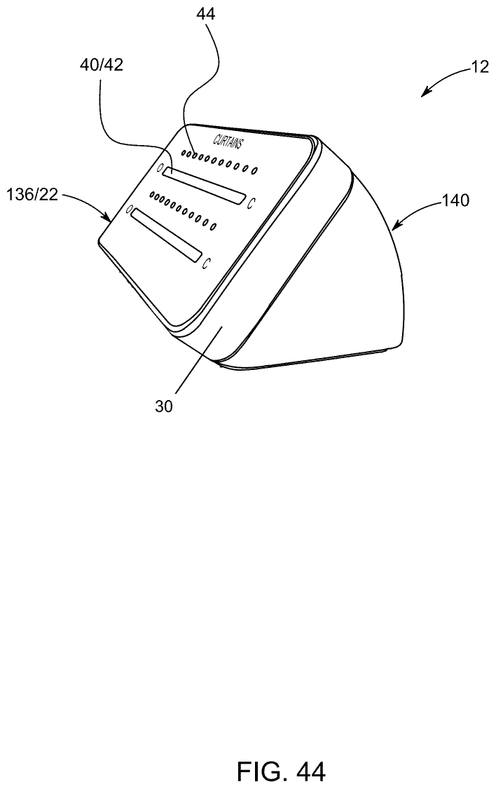

FIG. 45 shows a flowchart of an example process for operating a remote in the background mode and active mode, in accordance with one or more embodiments.

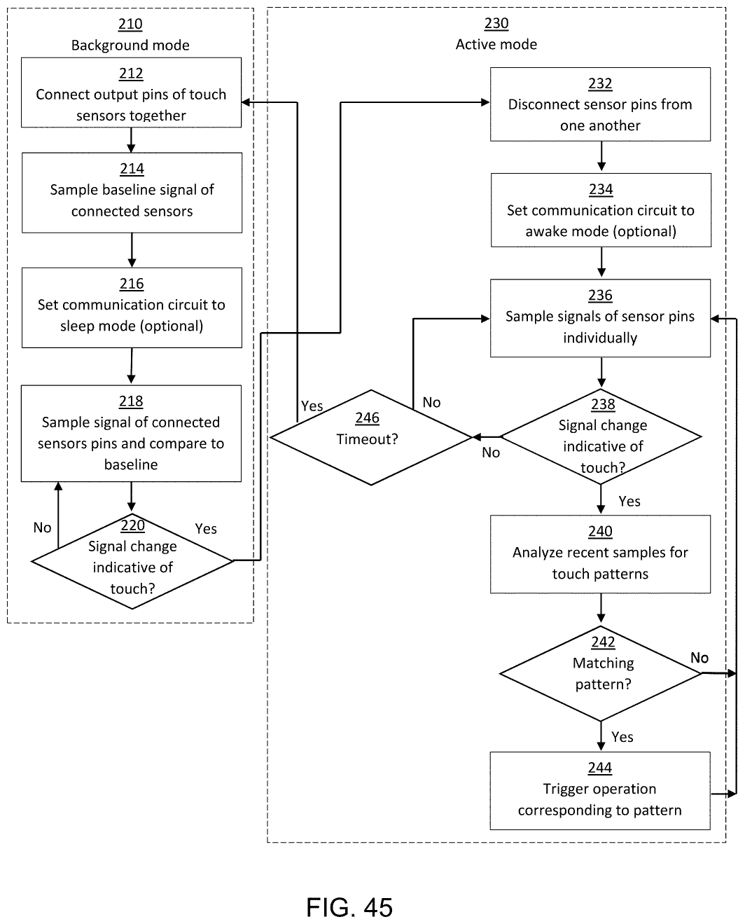

FIG. 46 shows a diagram of a remote control, in accordance with one or more embodiments; and

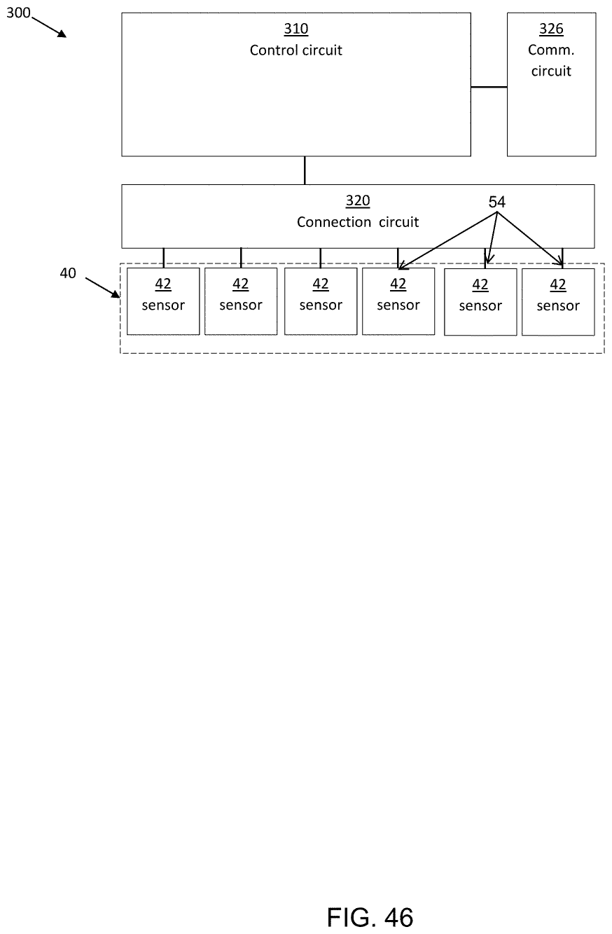

FIG. 47 shows a diagram of a control circuit, in accordance with one or more embodiments.

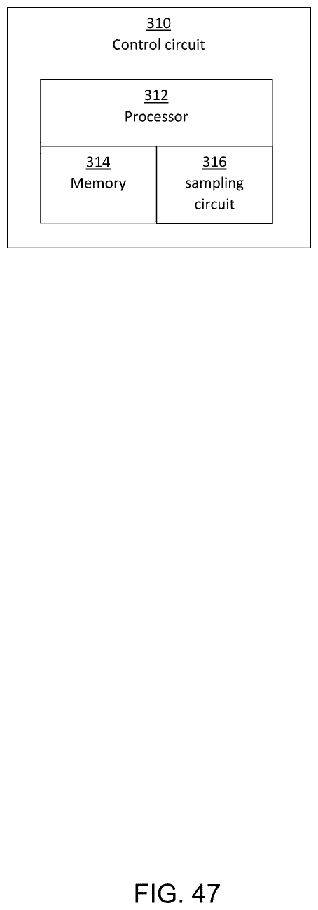

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure. Moreover, although some disclosed embodiments may be described in the context of applications for controlling motorized window treatments, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “A but not B,” and “B but not A.” As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, the disclosure is shown and described as being used in association with a window covering, however the disclosure is not so limiting. Instead, one of ordinary skill in the art will appreciate that the remote control system and method of use and attachment means, presented herein, can be applied to any mechanical device or electrical device, without limitation. Other examples of these various applications are any applications which may be used with a remote control, including but not limited to, ceiling fans, lamp or lamp assemblies, televisions, other electronic and mechanical equipment, and the like. The system is merely shown and described as being used in association with a window covering for ease of description and as one of countless examples.

As used herein, the term window covering refers to any covering such as a blind, drapery, roller shade, venetian blind or the like, used especially in association with windows. This term is in no way meant to be limiting. Instead, one of ordinary skill in the art will appreciate that the system presented herein can be applied to any window covering, without limitation. Going a step further, while use of the remote described herein is identified as being used with a window covering, the system is not so limited as use with a motorized window covering is only one of countless examples of potential use. Instead, it is hereby contemplated that the remote control system presented herein may be used with any wirelessly controlled device, including but not limited to, motorized window coverings.

### System:

With reference to the figures, a remote control system 10 (system 10) is presented. System 10 may be formed of components of any suitable size, shape, design, technology, and in any arrangement or configuration to facilitate wireless control of one or more devices by a user via a touch control interface. In one or more embodiments, the components of system 10 are configured to provide power efficient operation by operating a remote control of system 10 in an active mode 230 in response to user input and a background mode 210 in response to inactivity.

In one or more embodiments, system 10 includes a remote control 12 configured to control the one or more devices in response to user input to a touch control interface assembly 40 of remote control 12.

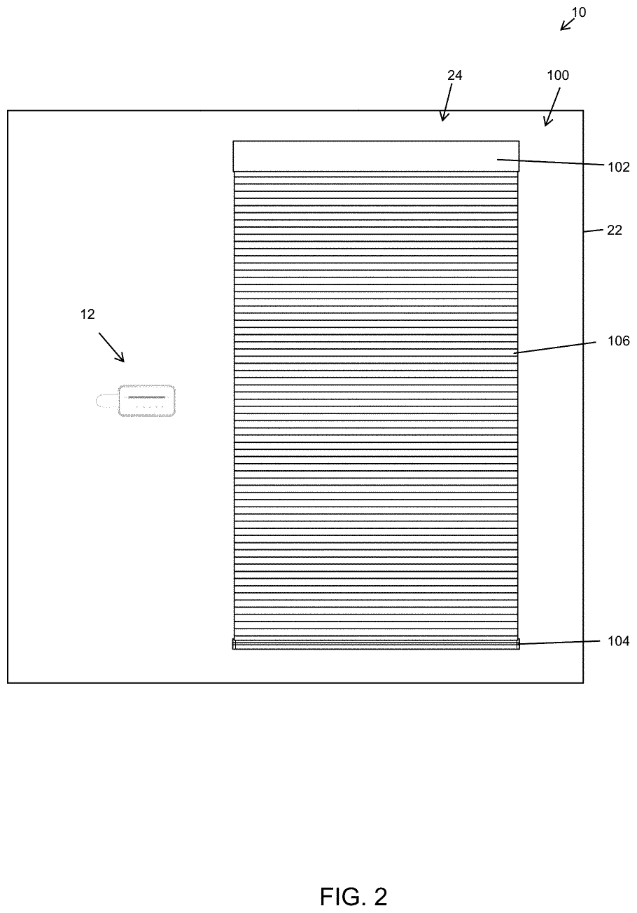

As an illustrative example, in one or more embodiments, remote control 12 may be configured to control a number of motorized window coverings 24 of system 10 which are communicatively connected to remote control 12. Remote control 12 may be suited to control one or more window coverings 24 that open and close such as roller shades, Venetian shades, honeycomb shades 100, or the like. Additionally, remote control 12 is well suited to control window coverings 24, in combination with other equipment. As one example of a window covering 24, which remote control 12 can control, a honeycomb shade 100 is shown in FIG. 2. In the arrangement shown, as one example, honeycomb shade 100 includes a header 102, a bottom bar 104, and a shade material 106 which extends between a header 102 and a bottom bar 104. Honeycomb shade 100 is shown in a closed position and remote control 12 is used to control the vertical position of the bottom bar 104.

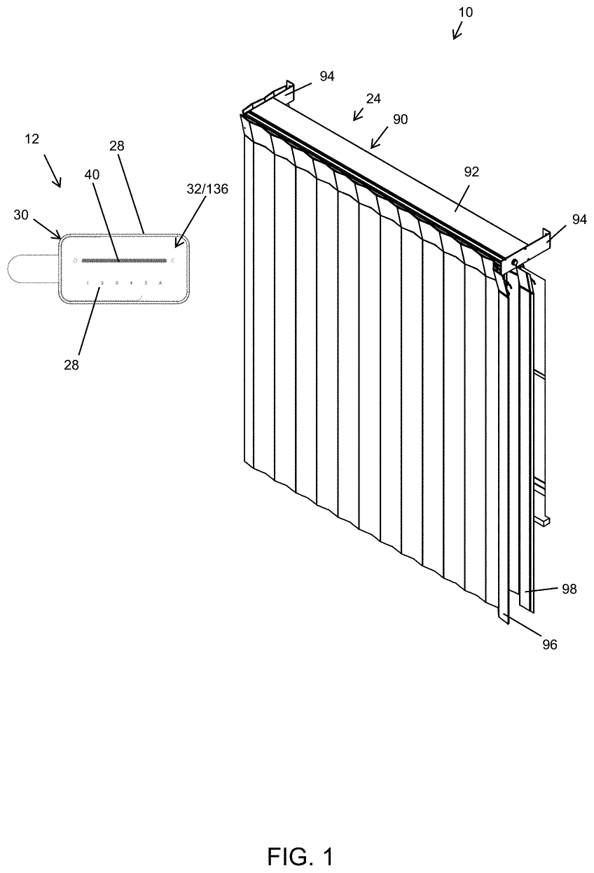

As another example, remote control 12 is also well suited for a drapery 90. In the arrangement shown, as one example, drapery 90 includes a support member 92 connected adjacent its ends to support brackets 94. A blackout curtain 96 and sheer curtain 98 hang down from support member 92. Blackout curtain 96 and sheer curtain 98 slidably move along the length of support member 92 between an open and closed position. While drapery 90 shown in FIG. 1 opens and closes from one side, in an alternative arrangement, drapery 90 is center opening or closing. All of these arrangements of a drapery 90, as well as a honeycomb shade 100 or any other form of a window shade assembly are well suited for the functionality of remote control 12.

In one or more embodiments, system 10 includes a wall mount plate 14 configured to receive and hold remote control 12. Remote control 12 and wall mount plate 14 are configured to facilitate easy and convenient removal and replacement of remote control 12 from a docked position while being aesthetically pleasing in design. Wall mount plate 14 may be any suitable size, shape, design suitable to facilitate docking of remote control 12. In a shown arrangement, as one example, wall mount plate 14 is generally planar having a generally rectangular back side 112 for attachment to a wall, and a generally planar and generally rectangular front side 110 for docking with remote control 12. In the arrangement shown, as one example, wall mount plate 14 has a thin peripheral edge 114 formed by side edges 118 and top and bottom edges 116 of wall mount plate 14. The thin peripheral edge 114 provides a low profile of wall mount plate 14.

In some embodiments, a cushioning member 124 may be attached to wall mount plate 14 or remote control 12. Cushioning member 124 may be configured, for example, to provide cushioning when remote control 12 makes contact with the wall and/or wall mount plate 14, while being aesthetically pleasing in design. Cushioning member 124 may be any suitable size, shape, design suitable to facilitate cushioning when remote control 12 contacts wall mount plate 14. In the arrangement shown, as one example, cushioning member 124 includes an opening 125 positioned at its approximate center that is sized and shaped to receive wall mount plate 14 therein with close tolerances. The reception of wall mount plate 14 within opening 125 of cushioning member 124 helps to provide alignment of remote control 12 with wall mount plate 14. The reception of wall mount plate 14 within opening 125 of cushioning member 124 helps to align magnetic members 18 and 20 of remote control 12 and wall mount plate 14 so as to facilitate stronger magnetic connection between magnetic members 18 and 20.

In one or more embodiments, for example, system 10 includes the following components: a remote control 12, a wall mount plate 14, a cushioning member 124, and may also include one or more magnetic members (18/20) and one or more devices communicatively connected to remote control 12.

### Remote Control:

System 10 includes a remote control 12. Remote control 12 may be formed of components of any suitable size, shape, design, technology, and in any arrangement or configuration to facilitate wireless control of one or more devices communicatively connected to remote control 12 in response to user input via a touch control interface assembly 40. For example, in the context of a system configured for controlling motorized window coverings 24, remote control 12 may be configured to provide quick and convenient control of motorized window coverings 24 from a distance, as well as control of other electronics and mechanical equipment, in an easy to use and aesthetically pleasing manner.

### Body 30:

In one or more shown arrangements, for example, remote control 12 includes a body 30. Body 30 is formed of any suitable size, shape and design and is configured to be a structural component of remote control 12. In the arrangement shown, as one example, body 30 includes a front side 32 and a back side 34. In the arrangement shown, as one example, body 30 is connected to front plate 136 and back plate 138 form a hollow interior 46 there between in which other components of remote control 12 are housed.

Body 30 may be any suitable size, shape, design suitable to provide a hollow interior for housing of components and user operability for a remote control 12. In one or more arrangements shown, for example, body 30 has an exterior peripheral edge 28, formed by sides of body 30, which is generally square to the planes formed by the front and back surfaces of remote control 12. That is, exterior peripheral edge 28 includes top and bottom edges 36, which are generally square to the planes formed by front side 32 and back side 34 surfaces, and exterior peripheral edge includes side edges 38 which are generally square to the planes formed by the front and back surfaces of remote control 12.

In the arrangement shown, as one example, the top and bottom edges 36 extend in approximate parallel spaced relation to one another. In the arrangement shown, as one example, the top and bottom edges 36 extend in approximate perpendicular alignment to opposing side edges 38 which connect at the ends of the top and bottom edges 36. In the arrangement shown, as one example, remote control 12 also includes rounded corners and rounded edges for improved aesthetics and user friendly gripping and comfort. Remote control 12 may be generally square or rectangular when viewed from the front or back.

### Front Plate 136:

In one or more shown arrangements, for example, remote control 12 includes a front plate 136 configured to attach to front side 32 of body 30. Front plate 136 may be formed of any suitable size, shape, design suitable to facilitate touch control user input and/or display of information on a surface of front side 32 and facilitate user operability for remote control 12. In the shown arrangement, as one example, front plate 136 has an exterior peripheral edge 150, formed by side edges 154 and top and bottom edges 152 of front plate 136, which is generally square or rectangular when viewed from the front. In the arrangement shown, as one example, the top and bottom edges 152 extend in approximate perpendicular alignment to opposing side edges 145, which connect at the ends of the top and bottom edges 36. In the arrangement shown, as one example, front plate 136 is approximately the same size and shape as a front surface 32 of body 30 and is configured to attach to front side 32 edge of body 30.

In various embodiments, front plate 136 or different portions thereof may be transparent to facilitate display of status indicators (such as lights or LEDs) positioned behind front plate 136, or may be opaque to hide components behind front plate 136 from view. In some embodiments, front plate 136 may include one or more openings to facilitate user access to buttons, display indicators, or the like.

In one or more arrangements, for example, front plate 136 may be connected to body 30 by a snapping arrangement and/or a snap fit arrangement. However, any other means known in the art for connecting two components such as bolting, screwing, snapping, welding, adhesives, and/or the like are hereby contemplated. In one arrangement, for example, front plate 136 may be configured to snap in place under one or more front side snap features 50 positioned on front side 32 of body 30.

Snap features 50 may be any suitable size, shape, or design configured to facilitate connection with front plate 136 and/or circuit board 60. In the arrangement shown, as one example, snap features 50 are positions along an interior of peripheral edge 28 of body 30 adjacent to the front side 32. As another example, in one or more arrangements, front plate 136 may be attached to body 30 by a collar configured to fit over and around and edge of front plate 136 and connect with body 30 using a snapping arrangement. Any other configuration of connecting two components together is hereby contemplated for use such as screwing, bolting, friction fitting, gluing, welding, or the like or any combination thereof.

### Back Plate 138/Base 140:

In one or more shown arrangements, for example, remote control 12 includes a back plate 138 or base 140 configured to attach to back side 34 of body 30. Back plate 138 and/or base 140 may be formed of any suitable size, shape, design suitable to provide a hollow interior with front plate 136 and body 30 for housing of components and user operability for remote control 12.

In one or more arrangements, for example, back plate 138 and/or base 140 may be connected to body 30 by any means known in the art for connecting two components such as bolting, screwing, snapping, welding, adhesives, and/or the like are hereby contemplated. In one arrangement, as is shown, back plate 138 or base 140 may be connected to body 30 by a plurality of snap features 48 in back side 34 of body 30 and lock features 144 and 146. Snap features 48 may be formed of any suitable size, shape, or design configured to facilitate connection with lock features 144 and 146 of back plate 138 or base 140.

In the arrangement shown, as one example, snap features 48 are positions along a peripheral edge 28 of body 30 adjacent to back side 34. Snap features 48 of body 30 are configured, for example, to align with and operably connect with corresponding lock features 144/146 of back plate 138 or base 140. Lock features 144 and 146 may be formed of any suitable size, shape, or design configured to facilitate operable connection with snap features 48 of body 30. In the arrangement shown, as one example, lock features 144 and 146 are deflectable hook members protruding outwardly from back plate 138 or base 140 and snap feature 48 are tabs configured to engage with the deflectable hook members with a combination of lateral sliding and frictional engagement.

Table Top Arrangement:

In one or more arrangements, remote control 12 may be configured for use as a table top remote control 12 with the addition of base 140. Base 140 may be formed of any suitable size, shape and design suitable to provide a hollow interior 46 with front plate 136 and body 30 for housing of components and support of remote control 12 on a table top surface.

In one or more shown arrangements, for example, a back side of remote control 12 includes a base 140 configured to attach to back side 34 edge of body 30 and support remote control 12 on a table top. In some arrangements, as is shown, body 30 of remote control 12 is generally flat and rectangular in shape with a generally planar front surface. Base 140 includes a bottom 164, sides 166, and a curved back 162. Base 140 includes generally rectangular portion, formed by front edges 168, which is configured to attach to back side 34 edges of body 30. Curved back 162 extends between sides 166 from a top edge of the front edges 168 to a back edge of bottom 164. Body 30 is connected to front plate 136 and base 140 to form a hollow interior 46 there between in which other components of remote control 12 are housed.

In one or more arrangements, for example, front plate 136 and base 140 may be connected to body 30 by any other means known in the art for connecting two components such as bolting, screwing, snapping, welding, adhesives, and/or the like are hereby contemplated. Body 30, front plate 136 and back plate 138 may be any suitable size, shape, design suitable to provide a hollow interior for housing of components and user operability for a remote control 12 on a table top surface.

In one or more embodiments, base 140 includes a weight 142 to stabilize base 140 when deployed on a table surface. Weight 142 may be formed of any suitable size, shape and design suitable to increase mass of base 140 and provide a lower center of gravity. In some implementations, weight 142 may be attached to an internal surface of bottom 164 of base 140 in a hollow interior of base 140. Additionally or alternatively, in some embodiments, weight 142 may be attached to an external surface of bottom 164 of base 140.

In one or more embodiments, base 140 includes a gripping member 148 attached to an external surface of bottom 164 of base 140. Gripping member 148 may include, for example, a rubber or other material having a high coefficient of friction. Gripping member 148 may be any suitable size, shape, design, or material configured to inhibit sliding of remote control 12 on a smooth table surface. In the arrangement shown, gripping member 148 covers the entire external surface of bottom 164 of base 140. Alternatively, in some embodiments, gripping member 148 may only cover a portion of the external surface of bottom 164. In one arrangement, gripping member 148 is formed of a material that has a high coefficient of friction.

Wall Mount Arrangement:

In some arrangements, as is shown, remote control 12 is generally flat and rectangular in shape and is configured for mounting or docking on a wall mount plate 14. In some arrangements, as is shown, remote control 12 is generally flat and rectangular in shape with a generally planar and rectangular front plate 136 and back plate 138 which extend in approximate parallel spaced relation to one another. In some arrangements, front plate 136 and back plate 138 are generally planar and rectangular and extend in approximate parallel spaced relation to one another.

Back plate 138 may be formed of any suitable size, shape and design suitable to form a hollow interior with front plate 136 and body 30 for housing of components and user operability for remote control 12. In one shown arrangement, as one example, back plate 138 has an exterior peripheral edge 156, formed by side edges 160 and top and bottom edges 158 of back plate 138, which is generally square or rectangular when viewed from the front. In the arrangement shown, the top and bottom edges 158 extend in approximate perpendicular alignment to opposing side edges 160, which connect at the ends of the top and bottom edges 36. In the arrangement shown, as one example, back plate 138 is approximately the same size and shape as a back surface 34 of body 30 and is configured to attach to back side 34 edge of body 30.

In some arrangements, as is shown, back plate 138 includes one or more access holes 330 configured to provide user access to one or more controls. For example, access holes 330 may provide access to one or more button on circuit board 60. Such buttons may be used, for example, to facilitate programming or resetting remote control 12 by a user. In the shown arrangement, access holes 332 in remote magnetic member 20 are aligned with access holes 330 to provide access through remote magnetic member 20 and back plate 138. It is contemplated that remote control 12 may additionally or alternatively include access holes in various other components of remote control 12 to facilitate user access.

Back plate 138 may include one or more features configured to facilitate docking of remote control 12, for example, on a wall mount plate. Such features may include, for example, mechanical attachments means (e.g., hooks, clamps, snapping features and/or other attachment mechanisms known in the art) and/or magnetic attachment means. For example, in some implementations, back plate 138 includes a wall magnetic member 18 configured to facilitate magnetic attachment with a wall mount plate 14.

### Magnetic Members 20:

Magnetic member 20 may be formed of any suitable size, shape and design and is configured facilitate magnetic connection to a wall magnetic member 18 of wall mount plate 14. In the shown arrangement, as one example, a remote magnetic member 20 is operably connected to an external surface of back plate 138 of remote control 12. Alternatively, in one or more embodiments, remote magnetic member 20 may be positioned behind back plate 138 inside of remote control 12. One or both of magnetic members 20 and 18 are magnets. In some embodiments, one of members 20 and 18 is a magnet and the other is a ferrous or other material that a magnet may attract to.

In some embodiments, magnetic members 20 and 18 may also be configured with provider alignment and orientation of remote control 12 on wall mount plate 14. In one arrangement, remote magnetic member 20 may be a generally elongated rectangular member that is positioned within hollow interior 46 of remote control 12 and extends a length parallel to the length of remote control 12. In the arrangement shown, as one example, remote magnetic member 20 is equally spaced between sides of remote control 12 and extends all the way or most of the way between the ends of remote control 12. In one arrangement, remote magnetic member 20 is sized and shaped to be received within a magnetic member recess positioned within the interior surface of back side 34 of remote control 12. In this arrangement, remote magnetic member 20 may be prevented from escaping from the magnetic member recess by adhesive, mechanical attachment (e.g., snap features, screwing, bolting or the like), and/or any other attachment means known in the art or combination thereof). In an alternative arrangement, remote magnetic member 20 is formed within the material of back side 34, thereby permanently preventing the escape of remote magnetic member 20, short of breaking the back side 34.

In some embodiments, remote magnetic member 20 may additionally be configured to provide self-centering and self-orienting of remote control 12 on wall mount plate 14. That is, in some implementations, when remote control 12 is placed on wall mount plate 14, remote control 12 will self-orient meaning that remote control 12 will spin in a clockwise or counter-clockwise direction to align remote magnetic member 20 of remote control 12 with wall magnetic member 18 of wall mount plate 14 so as to automatically achieve the same orientation regardless of the manner in which remote control 12 is installed on wall mount plate 14. Similarly, in some implementations, when remote control 12 is placed on wall mount plate 14 remote control 12 will self-center (i.e., remote control 12 will move vertically and/or laterally to precisely align remote magnetic member 20 of remote control 12 with wall magnetic member 18 of wall mount plate 14). In this way, system 10 ensures that remote control 12, when installed on the wall mount plate 14 is always pointed up (or any other desired direction) and is centered on the wall mount plate 14, thereby concealing the slightly smaller wall mount plate 14.

### Power Supply 70:

A power supply 70 is also connected to circuit board 60 that is held within the hollow interior 46 of remote control 12. The power supply may be any suitable size, shape, design, technology, and in any arrangement or configuration suitable to facilitate powering circuits of remote control 12. In various embodiments, for example, power supply 70 may include batteries, solar cells, energy harvesters, wireless and/or wire power supplies or various combinations thereof. In one arrangement, as is shown, power supply 70 is a battery 72 connected to a battery printed circuit board (PCB) 76 by power wires 74. Battery PCB 76 may be mounted to circuit board 60. When battery PCB 76 is connected to circuit board 60, power supply 70 provides power for circuits disposed on circuit board 60 (e.g., circuits 300).

### Pull Tab 78:

In the arrangement shown, as one example, remote control 12 includes a pull tab 78. Pull tab 78 is formed of any suitable size, shape and design and is configured to isolate power supply 70 from circuit board 60 until remote control 12 and corresponding equipment are ready for operation. Pull tab 78 rests between power supply 70 and circuit board 60 from the time of manufacturing to the first time the device is to be used on the consumer end. Pull tab 78 creates a block or insulator between power supply 70 and circuit board 60 which serves to preserve the supply of power supply 70, until power supply 70 is needed. Additionally, remote control 12 includes a slot (not shown) to provide an egress for removal of the pull tab. When pull tab 78 is removed, one or more electrical contacts on power supply 70 contact one or more electrical contacts on battery PCB 76 to facilitate powering of remote control 12.

### Adhesive 12:

In one or more embodiments, remote control 12 includes an adhesive 16 configured to facilitate attaching battery PCB 76 to the body 30. Adhesive 16 is formed of any suitable size, shape, material and design and is configured to facilitate attaching the battery PCB 76 to the body including, for example, any glue, mucilage, paste, cement, epoxy or other substance which is capable of holding battery PCB 76 in place. Additionally or alternatively, in some embodiments, adhesive 16 may be used to attach other components of remote control 12 or system 10 such as, for example, attaching remote magnetic member 20 to back plate 138 of remote control 12. Alternatively, battery PCB 76 is attached by any other manner, method or means such as screwing, bolting, welding, adhering, snap fitting, friction fitting, riveting, or the like or any other manner, method or means of connecting two components together or any combination thereof

### Circuit Board 60:

In the arrangement shown, as one example, remote control 12 includes a circuit board 60. Circuit board 60 is formed of any suitable size, shape and design and is configured to support and electrically connect many of the electronic components of remote control 12. In the arrangement shown, as one example, circuit board 60 is positioned between front side 32 and back side 34 of body 30. Circuit board 60 is formed of any suitable size, shape and design to facilitate support and/or connection of circuit components.

In one arrangement, as is shown, circuit board 60 is a generally rectangular shape that extends across most of the area within hollow interior 46. Circuit board 60 is generally planar in shape a thin cross section. Circuit board 60 has a front surface 172 a back surface 174 extending between side edges 178 and between top and bottom edges 180.

In the arrangement shown, as one example, circuit board 60 includes a touch control interface assembly 40 and/or touch control interface assembly 40 is attached to circuit board 60 and includes a plurality of touch sensitive sensors 40 that are configured to detect user interaction. The plurality of touch sensitive sensors 42 may be responsive to proximity of small voltages being transferred to the screen, and in turn, the touch sensitive sensors 42 relay this information to the circuit board 60.

One manner of holding circuit board 60 between front side 32 and back side 34 is by closely and tightly sizing and shaping circuit board 60 to fit therein such that when front side 32 and back side 34 are connected to one another, thus circuit board 60 is lockingly sandwiched there between in tight frictional engagement. In one or more embodiments, circuit board 60 may also include one or more connector members (not shown) that extend outward from the edges of circuit board 60. These connector members may be configured to be received within corresponding features in the front side 32 and/or back side 34 of remote control 12 and are configured to position and hold circuit board 60 precisely within the hollow interior 46 of remote control 12.

In one arrangement, circuit board 60 includes all the necessary componentry to operate remote control 12, including touch control interface assembly 40, a communication circuit 326 (e.g. receiver or transceiver), antenna 328, control circuit 310 (e.g., a processor circuit 312, memory 314, sampling circuit 316), connection circuitry 320, and/or and any other component needed, all of which is electrically connected through and/or supported by circuit board 60.

### Touch Control Interface Assembly 40:

In one or more embodiments, remote control 12 includes a touch control interface assembly 40 having a plurality of touch sensitive sensors 42. Touch control interface assembly 40 may be formed of any number of touch sensitive sensors of any suitable size, shape, design, or technology (e.g., capacitive touch sensors and/or resistive touch sensors), and in any arrangement or configuration to facilitate touch based control of various devices and/or functions by a user. As an illustrative example, in one or more embodiments, the touch control interface assembly 40, is configured to facilitate input touch based inputs various control capacities including, for example, dimming, changing motor speeds of fans, opening or closing window coverings to different levels, and more.

In one or more embodiments, touch control interface assembly 40 may be elongated and rectangular in shape, when viewed from the front. In some embodiments, touch control interface assembly 40 is located on the front side 32 of remote control 12. Alternatively, in some embodiments, touch control interface assembly 40 may be located along another spot of remote control 12. In one or more embodiments, touch sensitive sensors 42 of touch control interface assembly 40 are arranged in an elongated horizontal alignment along the front side 32 of remote control 12. In the context of controlling motorized window treatments, an elongated horizontal alignment of touch control interface assembly 40 may provide an intuitive interface for horizontal actuation of window coverings 24, that is gauging the amount of opening and closing of roller shade, venetian and/or honeycomb shades 100 or drapery 90 in correlation with the amount of slide a user initiates across the touch control interface assembly 40. In one or more embodiments, touch control interface assembly 40 may have a plurality of zones for actuation. That is, when different zones of touch control interface assembly 40 are initiated by a user, different signals are sent by remote control 12 depending on the distance a user slides their finger across the touch control interface assembly 40 and/or depending on the location of the touch of the control interface assembly 40 the user initiates. In other words, touch control interface assembly 40 is capable of a plurality of functions such as on/off functions or variable functionalities including dimming, or percentage capacity operations.

In different embodiments, remote control 12 may include various numbers of touch control interface assemblies 40. In one shown arrangement, as one example, remote control 12 includes first and second touch control interface assemblies 40, each including eleven touch sensitive sensors arranged to form a touch control slider. The first touch control slider is positioned in an upper portion on the front plate 136 and a second touch control slider is positioned in a lower portion of front plate 136. These touch control sliders extend from side-to-side along the front plate 136 in parallel spaced relation to one another. However, any other number of touch control sliders are hereby contemplated for use such as one, two, three, four, five, six, seven, eight or more, each of which may be formed of any number of touch sensitive sensors 42. Various embodiments may include more or fewer touch control interface assemblies 40, may include more or fewer touch sensitive sensors 42, and/or may arrange sensors in various other touch sensor arrangements known in the art.

In different embodiments, various touch patterns may be used for users to select options, settings, commands, and/or other inputs via touch control interface assembly. Touch patterns may be defined by various characteristics including, for example, position, pressure, direction of movement, speed, and/or hesitation of user touches. In some implementations, for example, a set of one or more different touch patterns may be defined in a data file stored in a memory 314 on remote control 12. In some various implementations, touch patterns may be defined for various gestures including but not limited to tap, double tap, tap and hold (or dwell), flick, drag, swipe, back-and-forth movement, pinch, stretch, rotate, and/or outline of various shapes (e.g., curve, circle, triangle, zigzag, and/or square).

In some implementations, touch patterns may be used to facilitate sequential selection of multiple options (e.g., selection from a sub-control menu). For example, in some implementations, a touch pattern may include a first gesture that may be used to select a device or set of devices to be controlled and a second gesture used to select a desired command or setting. As an illustrative example, a remote control 12 may be used to control two different window treatments (e.g. automated set of semitransparent curtains and an automated set of blackout curtains). In one arrangement, for example, a user may trigger the first window treatment to open to a set position by touching a horizontal touchscreen and sliding over to a point corresponding to a desired position before releasing. The user may trigger the second window treatment to open to a set position by touching the touchscreen and holding briefly before sliding over to a point corresponding to a desired position of second window treatment before releasing.

### Indicators 44:

Remote control 12 includes a plurality of indicators 44. Indicators 44 may be formed of any suitable size, shape and design and are configured to clearly notify the user of current statuses of the various systems being controlled by remote control 12. Indicators 44 may be configured to notify the user of control options and other variables and notices available to a user to make use of remote control 12 more clear, easy, and efficient and to provide immediate real-time feedback to the user. In one arrangement, as is shown as one example, indicators 44 are a row of lights, LEDs or the like which are positioned in lateral alignment in the front side 32 of remote control 12 body 30, nearer one end of remote control 12. Alternatively, indicators 44 could be positioned along the top side of the front side 32 of remote control 12 or any other portion of remote control 12 and/or in any arrangement.

In some various arrangements, a remote control 12 may include one or more indicators 44 to indicate whether the remote is in active or background mode 210. For example, in one or more embodiments, a remote control 12 may include one or more LEDs configured to light upon entering the active mode 230 and remain lit until the remote control 12 returns back to background mode 210 due to inactivity. In some embodiments, indicators 44 may be configured to provide feedback to assist a user touch control input. For instance, in some embodiments, a series of indicators 44 may be positioned above a touch control slider formed by the touch control interface assembly 40 on a front side of remote control 12, with one indicator 44 associated with each touch sensitive sensor 42. The indicators 44 may be configured to selectively light to indicate a position of the touch control slider currently being touched by the user, to provide confirmation that input is being correctly received by the remote control 12. As another example, in some embodiments, a remote control 12 may be configured to trigger an action in response to a touch and hold input by the user. Indicators 44 may be configured to blink or flash to alert a user when the touch pad has been held for a sufficient amount of time to be recognized as a touch and hold input (or dwell).

In one or more embodiments, indicators 44 may be used to facilitate selection of a channel or group of devices to be controlled. In one arrangement, for example, remote control 12 is a multi-channel remote configured to control different electronic devices or different groups of devices on each channel. Indicators 44 may be configured to indicate which channel is selected. In this way, the user can select which channel remote control 12 will communicate on.

### Active/Background Modes of Operation:

In one or more embodiments, remote control 12 includes circuits configured to operate in a low-power background mode 210 when remote control 12 is not in use. For example, in some implementations, remote control 12 is configured to operate in an active mode 230 in response to detecting user input and operate in a lower power background mode 210 in response to inactivity. In one or more embodiments, remote control 12 may be configured to enter background mode 210, for example, when touch input has not been detected by touch control interface assembly 40 for a threshold period of time (e.g., 10 seconds, 30 second, 1 minute, 5 minutes, or a longer period).

In the active mode 230, a control circuit of remote control 12 is configured to monitor touch activity by sampling signals from outputs the plurality of touch sensitive sensors 42 individually. In the background mode 210, power is saved by electrically connecting or combining the plurality of touch sensitive sensors 42 together and monitoring touch activity by sampling a single signal from the combined output of a the plurality of touch sensitive sensors 42.

In one or more embodiments, remote control 12 is configured to save power in the background mode 210 by monitoring the plurality of touch sensitive sensors 42 together as a group. Remote control 12 is configured to electrically connect output pins 54 of touch sensitive sensors 42 together in the background mode 210. With output pins 54 of touch sensitive sensors 42 electrically connected control circuit 310 can determine whether any of touch sensitive sensors 42 are being touched by a user from measurement of a single output pin 54 of the touch sensitive sensors 42.

While operating in the active mode 230, output pins 54 of touch sensitive sensors 42 are individually measured to determine whether each touch sensitive sensor 42 is being touched or not in order to determine positions and/or movement or user touches on remote control 12. Individual measurement of output pins 54 of touch sensitive sensors 42 may be performed sequentially or concurrently.

Additionally or alternatively, in some embodiments, remote control 12 may be configured to further save power by sampling signals from touch sensitive sensors 42 less frequently than while operating in the active mode 230. For example, in one or more embodiments, signals from touch sensitive sensors 42 may be sampled 100 times per second (i.e., 100 Hz) while operating in the active mode 230 and sampled 20 times per second (i.e., 20 Hz) while operating in the background mode 210. In some implementations, for example, sampling touch sensitive sensors 42 together at a 20 Hz may permit background mode 210 monitoring of touch sensitive sensors 42 to be performed using less than 10 micro amps.

### Control Circuit Operation:

An example process for operating a remote control 12 in the background mode 210 is shown in block 210 and an example process for operating a remote control 12 in the active mode 230 is shown in block 230. Upon entering background mode 210 in block 210 output pins 54 of touch sensitive sensors 42 are connected together at block 212. Connecting output pins 54 of the touch sensitive sensors 42 allows touch sensitive sensors 42 to be monitored via a single measurement as though the touch sensitive sensors 42 were a single touch sensitive sensor of approximately equivalent total area. A baseline signal output by the connected sensors is sampled at block 214. Optionally, a communication circuit, processor and/or other circuits may be set to a background/low-power mode at block 216. At block 218, a signal from the connected output pins 54 of the combined touch sensitive sensors 42 is measured and compared to the baseline that was measured at block 214. If one of the touch sensitive sensors 42 is touched, the signal sampled from the connected output pins 54 will differ from that of the baseline. If change in the signal is not indicative of a touch at block 220, the process returns back to block 218 for another measurement and comparison. The process repeats in this manner until a signal change indicative of a touch is detected at decision block 220. When signal change is indicative of a touch is detected at decision block 220, the process transitions to active mode 230.

In one or more embodiments, the transition to active mode 230 may involve generation of one or more interrupts or signals to prompt various circuits of remote control 12 to wake up or perform certain actions. In some embodiments, for example, when active mode 230 is entered, the output pins 54 of touch sensitive sensors 42 are disconnected from one another at block 232. In some embodiments, an updated baseline may also be measured for operation in the active state. Optionally, a processor, communication circuit and/or other circuits previously set to background mode 210 (e.g., at block 216) may be set to operate in an active mode 230 at block 234. Signals of sensor output pins 54 are individually sampled at block 236. Sampling of the sensor output pins 54 may be performed sequentially or concurrently in various embodiments. In some implementations, output pins 54 are sequentially sampled one at a time and sampled values are stored in memory 314. Once output pins 54 of all touch sensitive sensors 42 are sampled, the resulting block of data may be compared to a baseline value to determine if and/or at which touch sensitive sensor(s) is/are being touched by a user.

If signal change is not indicative of a touch at decision block 238, the process proceeds to block 246. If no touch activity is detected for a threshold amount of time, the process is considered to be timed out, at decision block 246, and transitions to background mode 210. So long as the process does not time out, the process proceeds from decision block 246 back to block 236, where individual measurement of signals from output pins 54 of touch sensitive sensors 42 is repeated. The process continues in this manner until a signal change indicative of a touch is detected (or until timeout occurs). When such signal change is detected at decision block 238, the process analyzes at block 240 for touch patterns. In some implementations, for example, a set of one or more different patterns may be defined in a data file stored in a memory 314 on remote control 12. If the recent samples do not match a defined touch pattern, at decision block 242, the process continues back to block 236 to continue sampling. If the recent samples do match a defined touch pattern, at decision block 242, an operation or action corresponding to the touch pattern is triggered at block 244. This may include transmitting a wireless control signal to control operation of a drapery 90, honeycomb shade 100, or any other motorized window shade or other electronic device. After triggering the operation, the process continues back to block 236.

### Circuits of Remote Control:

Remote control 12 may be implemented using remote circuits is formed of any suitable size, shape, design, or technology and in any arrangement or configuration. In a shown arrangement, as one example, circuit 300 may be used to implement functionality of remote control 12, in accordance with one or more embodiments. The circuit 300 may be provided, for example, on circuit board 60. The circuit 300 includes a control circuit 310 and a communication circuit 326 connected thereto. Control circuit 310 is also connected by connection circuit 320 to a touch control interface assembly 40 having a plurality of touch sensitive sensors 42. The control circuit 310 is configured to control operation of one or more devices communicatively connected to the communication circuit 326 in response to user input received via touch sensitive sensors 42

In one or more embodiments, the control circuit 310 is configured to operate the remote circuit 300 in an active mode 230 and a background mode 210. In one or more implementations, the control circuit may operate the remote circuit 300 according to the process described, for example, with reference to process blocks 210 and 230. In one or more implementations, control circuit 310 may signal connection circuit 320 to connect output pins 54 of sensors 324 together when operating in the background mode 210 to enable sensors to be sampled together as a group. Conversely, control circuit 310 may signal connection circuit 320 to disconnect output pins 54 of touch sensitive sensors 42 from each other when operating in the active mode 230 to permit touch sensitive sensors 42 to be sampled individually.

In one or more embodiments, the control circuit 310 may be configured to control various devices communicatively connected to the communication circuit. In some embodiments, the control circuit 310 may be configured to communicate with, report status events/information to, receive commands from, and/or send commands one or more devices over connected to communication circuit 326. The communication circuit 326 may be configured to communicate using various protocols over various networks including, for example, 802.11/Wi-Fi, Wi-Max, Bluetooth, UltraWideband (UWB), 802.15.4/ZigBee, ZWave, GSM/EDGE, UMTS/HSPA+/HSDPA, CDMA, LTE, and/or FM/VHF/UHF networks.

In some embodiments, system 10 may additionally include one or more external sensors (not shown), remotely connected to control circuit 310 via communication circuit 326. In one or more embodiment, control circuit 310 may be configured to provide automated control of one or more features, functions, and/or operations in response to data from the external sensors in addition to or in lieu of data from touch sensitive sensors 42. Additionally or alternatively, in some embodiments, control circuit 310 of remote control 12 may be configured to provide such automated control of the features, functions, and/or operations based on data received from other devices and/or third parties over one or more communication networks (e.g., from user's smart-phone, user's car, security system, weather reporting services, and/or social networking sites).

In one or more embodiments, control circuit 310 may be configured to monitor, learn, and modify automated control of one or more features, functions, and/or operations of the system 10. For instance, a control circuit 310 may be configured to monitor and locally or remotely store data relating to user commands and operation of the system. In one or more embodiments, control circuit 310 may be configured to analyze the data and learn, over time, a desired operational behavior. Such learning may include, for example, generation and refinement of classifiers and/or state machines configured to map input data values to desired operations to be performed by the control circuit. In various embodiments, analysis by the control circuit may include various guided and/or unguided artificial intelligence/machine learning techniques including, but not limited to: neural networks, genetic algorithms, support vector machines, k-means, kernel regression, discriminant analysis and/or various combinations thereof. In different implementations, analysis may be performed locally, remotely, or a combination thereof.

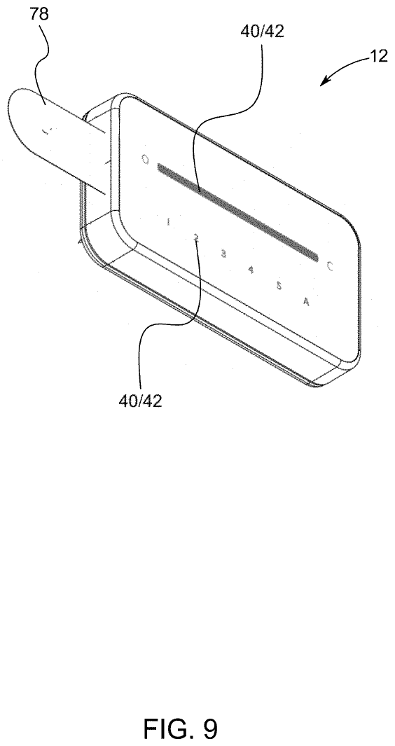

In different embodiments, control circuit 310 may be implemented using various circuit arrangements. In one arrangement, for example, control circuit 310 may include a processor 312, a memory 314 coupled to the processor 312, and a sampling circuit 316 coupled to the processor 312. In some embodiments, sampling circuit 316 may include, for example, an analog to digital converter configured to sample signals from output pins 54 of touch sensitive sensors 42. In some embodiments, sampling circuit 316 may be configured to provide sampled signals to processor 312 and/or store samples in memory 314. Some embodiments, the processor 312 may be configured to execute a set of instructions in the memory 314 that cause the processor 312 to cause control circuit 310 to operate the remote circuit 300 in an active mode 230 and a background mode 210 as described, for example, with reference to process blocks 210 and 230 in FIG. 9. In some implementations, the control circuit 310 may include a separate mode monitor circuit configured to monitor touch activity/inactivity in active mode 230 and background mode 210 and prompt the control circuit to operate in active mode 230 or background mode 210. Use of a separate mode monitor circuit, may permit processor 312 to be placed in a low power or inactive state when the control circuit 310 is operating in background mode 210. It is contemplated that any other configuration or arrangement may be used to implement control circuit 310.

Various blocks, modules, or other circuits may be implemented to carry out one or more of the operations and activities described herein and/or shown in the figures. In these contexts, a “block” (also sometimes “logic circuit”, “control circuit,” “controller,” or “module”) is a circuit specifically configured to carry out one or more of these or related operations/activities. For example, control circuits 310 may be discreet logic circuits or programmable logic circuits configured for implementing these operations/activities, as shown in the figures and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain embodiments are directed to a computer program product (e.g., nonvolatile memory device), which includes a machine or computer-readable medium having stored thereon instructions which may be executed by a computer (or other electronic device) to perform these operations/activities.

The disclosed remote control system 10 is thought to be useful for various applications having devices that are operable by remote control. In various embodiments, and various applications, the layout front plate 136, touch sensitive sensors 42, and indicators 44, and gestures used by users to cause remote control 12 to perform actions may be adjusted to suit the particular application.

### In Operation:

With reference to FIGS. 1, 2, and 12, as one illustrative example, system 10 includes drapery 90 that is motorized and operable by remote control 12. In this example arrangement, system 10 also includes honeycomb shade 100, which is also motorized and operable by remote control. In this arrangement, as one example, drapery 90 and honeycomb shade 100 are communicatively connected to remote control 12 (e.g., via communication circuit 326). In this arrangement, as one example, drapery 90 is configured to adjust lateral position of blackout curtain 96 and/or sheer curtain 98 (e.g., to an open position, to a closed position, or to any position in between), in response to commands from remote control 12. Similarly, in this example honeycomb shade 100 is configured to adjust a vertical position of shade material 106 in response to commands from remote control 12

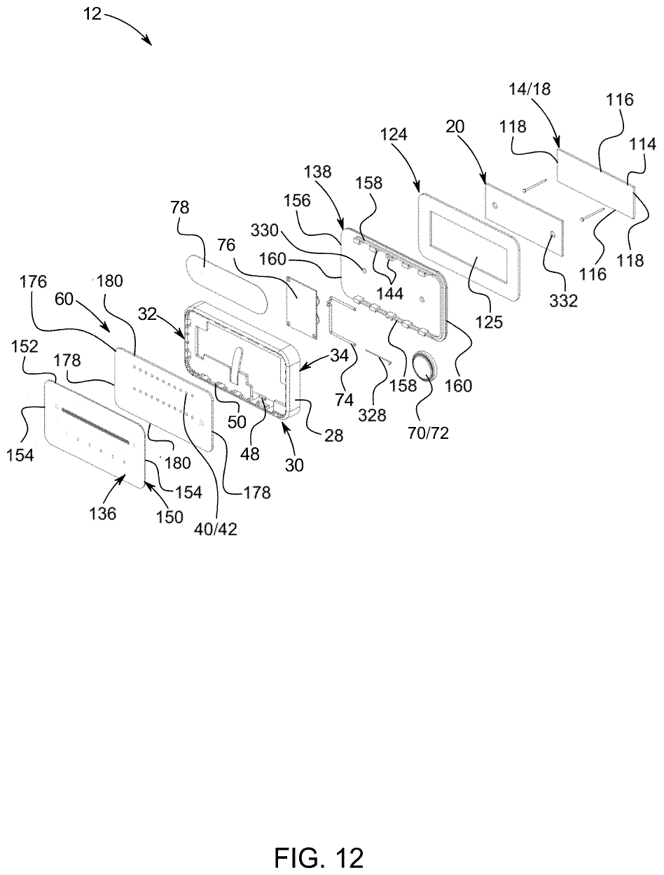

In this example arrangement, remote control 12 includes two touch control interface assemblies 40 having touch sensitive sensors 42 arranged as touch control sliders. As shown in FIG. 12, a lower touch control slider (lower touch control interface assembly 40) is located behind or adjacent to a sequence of markings “1 2 3 4 5 A” on front plate 136. In one configuration of remote control 12, for example, lower touch control interface assembly 40 may be used for selection of a channel to be controlled by remote control 12. For instance, remote control 12 may be configured to independently control devices on six channels corresponding to respective markings “1 2 3 4 5 A”. As an illustrative example, remote control 12 may be configured to control blackout curtain 96 on channel “1”, control sheer curtain 98 on channel “2”, control honeycomb shade 100 on channel “3”, and jointly control all of the window treatments (i.e., blackout curtain 96, sheer curtain 98, and honeycomb shade 100) on channel “A”. In this example arrangement, an upper touch control slider (upper touch control interface assembly 40) is located behind a horizontal bar marking on front plate 136. In an example configuration, the upper touch control interface assembly 40 may be used to adjust a position of the selected drapery. In this example arrangement, indicators 44 are deployed behind front plate 136 above the touch control interface assemblies 40, for example, as shown in FIG. 12. In this example arrangement, the indicators 44 are configured to light up to provide visual feedback to a user and facilitate user control of drapery 90 and honeycomb shade 100.

In this example arrangement, control circuit 310 is configured to operate remote control 12 in a background mode 210 to save power when remote control 12 is not in use as previously described. When a user first touches front plate 136 to operate remote control 12, remote control 12 will typically be operating in the background mode 210. As previously described, in background mode 210, all touch sensitive sensors 42 are periodically measured together to save power. When the user touches any touch sensitive sensor 42, control circuit 310 cannot determine which position is being touched by the user. However, the touch will be detected and prompt control circuit 310 to operate remote control 12 in active mode 230. Upon entering active mode, control circuit 310 starts measuring the touch sensitive sensors 42 separately, thereby permitting control circuit 310 to determine the positions(s) being touched by the user.

In this example arrangement, while in the active mode, the remote control 12 is configured to illuminate an indicator 44 corresponding to the position of the touch control interface assembly 40 touched by the user as feedback. In some embodiments, the transition to active mode 230 may occur so quickly that, from the user perspective, the indicator may seem to light instantaneously in response to the user's initial touch.

In some arrangements, for example, when operating in active mode 230, remote control 12 may illuminate an indicator 44 above one of the markings “1 2 3 4 5 A” to show which channel is selected to be controlled by the remote control 12. In this example arrangement, upon entering active mode 230 in response to the initial touch by the user, remote control 12 illuminates an indicator 44 to indicate the currently selected channel (e.g., the last channel that was last selected by the user). If a different channel is desired, the user may select a different channel by touching the lower touch control interface assembly 40 on the front plate 136. In this example arrangement, the remote control 12 illuminates an indicator 44 corresponding to channel closest to the position touched by the user. In this example arrangement, if the user slides a finger along the lower touch control interface assembly 40, indicators 44 will be illuminated to follow along with the user's finger. Once an indicator 44 for the desired channel is illuminated, the user may select the channel by simply releasing the user's finger from the front plate 136.

Continuing with this illustrative example, the user may adjust the position of drapery corresponding to the selected channel (i.e., blackout curtain 96 and sheer curtain 98) using the upper touch control interface assembly 40 located behind a horizontal bar marking on front plate 136. Similar to the lower touch control interface assembly 40, in this example arrangement, remote control 12 is configured to illuminate indicators 44 under and/or above the horizontal bar marking to indicate a position being touched by a user. The user may slide the user's finger along the upper touch control interface assembly 40 to a desired position for the curtain. In this example arrangement, the far left position on the upper touch control interface assembly 40 corresponds to a fully open position for the curtain(s) and/or shade and the far right position on the upper touch control interface assembly 40 corresponds to a fully closed position for the curtain(s) and/or shade. The user may select a fully open position, a fully closed position or any position on the slider in between.

In this example arrangement, upon release of the user's finger, control circuit 310 sends a control command to drapery 90, via communication circuit 326, to cause drapery 90 to move the curtain(s) corresponding to the selected channel (e.g., blackout curtain 96 and/or sheer curtain 98) to the position selected by the user. In this example arrangement, once a desired position is touched, the user may select the position by simply removing the user's finger from the front plate 136. In this context, it is believed that use of a touch control interface assembly 40 to select a position between fully open and fully closed, provides an intuitive interface for either horizontal control of curtains or vertical control of shades, for example.

In this example arrangement, a user may easily select a desired position and walk away without having to wait and hold a control button until the drapery 90 or honeycomb shade 100 moves the blackout curtain 96, sheer curtain 98 and/or shade material 106 to the desired position. In addition, by the illumination of the desired position on the remote control 12, the remote control provides the user with a visual indication of the exact position the shade will move to. As a further example, a user may select channel “1” and input a desired position for blackout curtain 96. While blackout curtain 96 is being moved into the desired position, a user may select channel “2” and select a desired position for sheer curtain 98. While blackout curtain 96 is still being moved into the desired position, the user may then select channel “3” and input a desired position for honeycomb shade 100. As such, remote control 12 provides an efficient manner of controlling multiple implements.

In this example arrangement, the user may easily and quickly switch channels and select desired positions as previously described to independently or jointly adjust positions of blackout curtain 96, sheer curtain 98, and/or honeycomb shade 100 as desired. In this arrangement, as one example, when the user is done using remote control 12, remote control 12 will continue to operate in active mode 230 for a period of time (e.g., 30 seconds) to ensure that the user is in fact done using remote control 12. In this arrangement, for example, once no user input is detected for the threshold period, control circuit 310 returns to operating remote control 12 in the background mode 210 to conserve power as previously described. In this way, remote control 12 provides all the benefits of a touch remote, while providing elongated battery life.

### In Operation:

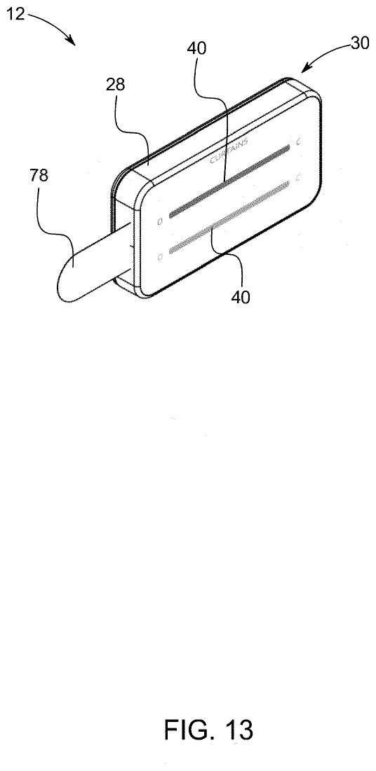

As another illustrative example, FIG. 13 shows remote control 12 with another layout of front plate 136 and arrangement of touch sensitive sensors 42 and indicators 44. In this example arrangement, remote control 12 includes two touch control interface assemblies 40 having touch sensitive sensors 42 arranged as touch control sliders. As shown in FIG. 13, a lower touch control interface assembly 40 is located behind a lower horizontal bar marking and an upper touch control interface assembly 40 is located behind an upper horizontal bar marking. In this example arrangement, a series of indicators 44 are positioned behind and/or above each touch control interface assembly 40 and are configured to light up to provide visual feedback to a user.

In this example arrangement, remote control 12 can be configured to independently control different devices (or groups of devices) on different channels. In one example configuration, remote control 12 may be configured to control devices on a first channel using the upper touch control interface assembly 40 and control devices on a second channel using the lower touch control interface assembly 40. For example, referring again to the drapery 90 shown in FIG. 1, the remote control 12 may be configured to control blackout curtain 96 using the upper touch control interface assembly 40 and control sheer curtain 98 using the lower touch control interface assembly 40.

In this example arrangement, as previously described, remote control 12 will typically be operating in the background mode 210 when a user first touches front plate 136.

In this example arrangement, control circuit 310 will switch to operating remote control 12 in active mode 230 in response to the user touching any portion of touch control interface assemblies 40. In this example arrangement, control circuit 310 starts measuring the touch sensitive sensors 42 separately upon entering active mode and will quickly determine the position being touched by the user, as previously described. In this example arrangement, remote control 12 is configured to illuminate an indicator 44 corresponding to the position of the touch control interface assembly 40 touched by the user as feedback.

In this example arrangement, the user may adjust the position of drapery 90 curtain (blackout curtain 96 or sheer curtain 98) corresponding to the touch control interface assembly 40 touched by the users by sliding the user's finger along the upper touch control interface assembly 40 to a desired position for the curtains and releasing. In this example arrangement, the far left position on the upper touch control interface assembly 40 corresponds to a fully open position for the curtain(s) and/or shade and the far right position upper touch control interface assembly 40 corresponds to a fully closed position for the curtain(s) and/or shade. The user may select a fully open position, a fully closed position or any position on the slider in between.

In this example arrangement, control circuit 310 sends a control command to drapery 90, via communication circuit 326 upon release of the user's finger to cause drapery 90 to move the curtain(s) corresponding to the selected channel (e.g., blackout curtain 96 and/or sheer curtain 98) to the position selected by the user.

In some implementations, remote control 12 may be configured to independently control two different channels from the upper touch control interface assembly 40 and two different channels from the lower touch control interface assembly 40. For example, each touch control interface assembly 40 may be configured to control a respective first channel by default and control a respective second channel when selected by the user. In this example arrangement, a user may select to temporarily control the second channel for a touch control interface assembly 40, for example, by touching the touchscreen and holding briefly (e.g., a dwell gesture) before sliding over to a point corresponding to a desired position for the second channel.

As an illustrative example, the upper touch control interface assembly 40 may be configured to control blackout curtain 96 of drapery 90 by default and configured to control honeycomb shade 100 in response to a dwell gesture by the user. To control honeycomb shade 100, in this example arrangement, the user touches the upper touch control interface assembly 40 and initially holds in position. In this example arrangement, after a threshold amount of time corresponding to a dwell gesture (e.g. 1, 2 or 3 seconds), the remote may illuminate three indicators 44 above the touch control interface assembly 40, one at the center of the touch and one on each side of the touch, to indicate touch position and also indicate that the user is controlling the second channel (i.e., honeycomb shade 100). In this example, the user then slides the user's finger over to the desired position and releases. In this example arrangement, control circuit 310 sends a control command to honeycomb shade 100 via communication circuit 326, upon release of the user's finger, to cause honeycomb shade 100 to move the shade material 106 to the position selected by the user. This arrangement essentially doubles the controlling capability of remote control 12 by giving each touch control interface assembly 40 a second control capability.

In this example arrangement, the user may easily and quickly switch channels and select desired positions as previously described to independently or jointly adjust positions of blackout curtain 96, sheer curtain 98, and/or honeycomb shade 100 as desired. In this example arrangement, remote control 12 will continue to operate in active mode 230 for a period of time (e.g., 30 seconds) after the user last touches remote control 12 to ensure that the user is done using remote control 12. In this example arrangement, control circuit 310 returns to operating remote control 12 in the background mode 210 once no user input is detected for the threshold period to conserve power as previously described.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims. The language of the claims is not intended to be interpreted as a means or step for performing a specified function under 35 U.S.C. 112(f) unless “means for” is expressly recited in the claims.

What is claimed is:

1. A touch remote control system, comprising:
a remote control,
wherein the remote control includes a housing;
wherein the remote control includes a circuit board;
wherein the remote control includes a first plurality of touch sensitive sensors;
the first plurality of touch sensitive sensors operatively connected to the circuit board;
wherein the remote control includes a control circuit, the control circuit operatively connected to the circuit board;
wherein the control circuit is configured to operate the remote control in an active mode and a background mode;
wherein when the control circuit is in an active mode, the control circuit is configured to individually sample signals from the plurality of touch sensors; and
wherein when the control circuit is in a background mode, the control circuit is configured to concurrently sample signals from the plurality of touch sensors that are connected together.

2. The system of claim 1, wherein:
the plurality of touch sensitive sensors have respective output pins and are configured to provide the signals, wherein the signals are indicative of sensed touch activity on the respective output pins; and
the remote control includes a connection circuit;
wherein the connection circuit is configured to electrically connect the output pins of the plurality of touch sensitive sensors together in the background mode; and
wherein the connection circuit is configured to electrically disconnect the output pins of the plurality of touch sensitive sensors from each other in the active mode.

3. The system of claim 1, wherein the control circuit is configured to operate the remote control in the background mode in response to the sampled signals being indicative of inactivity for a period of time exceeding a threshold amount specified in a memory of the control circuit.

4. The system of claim 1, wherein the control circuit is configured to transition the remote control from operating in the background mode to operating in the active mode, in response to signals sampled in the background mode being indicative of touch activity.

5. The system of claim 1, wherein the control circuit is configured to:
sample signals from output pins of the plurality of touch sensitive sensors at a first rate while operating the remote control in the active mode; and
sample signals from output pins a second rate, while operating the remote control in the background mode; wherein the second rate is less than the first rate.

6. The system of claim 1, wherein the plurality of touch sensitive sensors are directly connected to a front surface of the circuit board.

7. The system of claim 1, wherein when in an active state the control circuit samples each touch sensitive sensor individually and compares a value of the sampled signal to a stored value to determine if a touch has occurred.

8. The system of claim 1, wherein the control circuit includes a processor and a memory.

9. The system of claim 1, wherein the remote control includes a respective light emitting diode (LED) associated with each touch sensitive sensor of the plurality of touch sensitive sensors.

10. The system of claim 1, wherein the remote control includes a respective light emitting diode LED associated with each touch sensitive sensor of the plurality of touch sensitive sensors; wherein when a touch is detected on one touch sensitive sensor of the plurality of touch sensitive sensors, the LED associated with the one touch sensitive sensor illuminates.

11. A remote control system, comprising:
a remote control;
the remote control configured to operate in a background mode and an active mode;
wherein the remote control includes a plurality of touch sensitive sensors, each of the plurality of touch sensitive sensors having a respective output pin and configured to provide a respective signal indicative of touch activity detected by the touch sensitive sensor on the respective output pin;
wherein the remote control includes a connection circuit;
wherein the connection circuit is configured to electrically connect the output pins of the plurality of touch sensitive sensors together in the background mode;
wherein the connection circuit is configured to electrically disconnect the output pins of the plurality of touch sensitive sensors from each other together in the active mode; and
wherein the remote control includes a control circuit;
wherein the control circuit is configured to individually sample signals from the plurality of touch sensitive sensors in the active mode; and
wherein the control circuit is configured to concurrently sample signals from the plurality of touch sensitive sensors in the background mode.

12. The system of claim 11, wherein the remote control includes a communication circuit configured to control one of more devices communicatively connected to the communication circuit by a wireless medium in response to the signals sampled by the control circuit.

13. The system of claim 11, wherein the control circuit is configured to operate the remote control in the background mode in response to the sampled signals being indicative of inactivity for a period of time exceeding a threshold amount specified in a memory of the control circuit.

14. The system of claim 11, wherein the control circuit is configured to transition the remote control from operating in the background mode to operating in the active mode, in response to signals sampled in the background mode being indicative of touch activity.

15. The system of claim 11, wherein the control circuit is configured to sample the signals from output pins of the plurality of touch sensitive sensors at a first rate while operating the remote control in the active mode; and
wherein the control circuit is configured to sample one output pin a second rate, while operating the remote control in the background mode;
wherein the second rate is less than the first rate.

16. The system of claim 11, wherein the control circuit is configured to sample the signals from output pins of the plurality of touch sensitive sensors at a first rate while operating the remote control in the active mode; and
wherein the control circuit is configured to sample one output pin a second rate, while operating the remote control in the background mode;
wherein the first rate is approximately 100 Hz and the second rate is 10 Hz.

17. The system of claim 11, wherein the control circuit is configured to send a first control message to a first device communicatively connected to the remote control in response to sampled signals being indicative of a first touch pattern;
wherein the control circuit is configured to send a second control message to the first device communicatively connected to the remote control in response to sampled signals being indicative of a second touch pattern;
wherein the first control message is different than the second control message;
wherein the first touch patter is different than the second touch pattern.

18. The system of claim 11, wherein:
the remote control includes a circuit board;
the control circuit, connection circuit and plurality of touch sensitive sensors are mounted on the circuit board;
the remote further includes a body;
the body of the remote control has a front side, a back side, and an exterior peripheral edge;
the circuit board is mounted in a hollow interior of the body.

19. The system of claim 11, further comprising:
a magnetic member operatively connected to the remote control;
an adhering plate;
the adhering plate having a front side and a back side;
the adhering plate having an exterior peripheral edge;
wherein the adhering plate is planar in shape with the front side being flat and the back side being flat;
an adhesive;
the adhesive attached to the back side of the adhering plate;
wherein the adhering plate is configured to be adhesively attached to a wall using the adhesive;
wherein the remote control is configured to be magnetically attached to and removed from the adhering plate after the adhering plate is adhered to the wall;
wherein when the remote control is magnetically attached to the adhering plate the adhering plate is completely concealed behind the remote control.

20. A touch remote control system, comprising:
a remote control,
wherein the remote control includes a housing;
wherein the remote control includes a circuit board;
wherein the remote control includes a first plurality of touch sensitive sensors;
each of the first plurality of touch sensitive sensors having a respective output pin and configured to provide a respective signal indicative of touch activity detected by the touch sensitive sensor on the respective output pin;
wherein the remote control includes a control circuit, the control circuit operatively connected to the circuit board;
wherein the control circuit is configured to operate the remote control in an active mode and a background mode;
wherein the remote control includes a connection circuit;
wherein the connection circuit is configured to electrically connect the output pins of the first plurality of touch sensitive sensors together in the background mode;
wherein the connection circuit is configured to electrically disconnect the output pins of the first plurality of touch sensitive sensors from each other together in the active mode; and
wherein when the control circuit operates the remote control in the active mode, the control circuit is configured to individually sample signals from the first plurality of touch sensors; and
wherein when the control circuit the remote control in the background mode, the control circuit is configured to concurrently sample signals from the first plurality of touch sensors that are connected together.
